(19) United States
(12) Patent Application Publication
(10) Pub. No.: US 2010/0222928 A1
(43) Pub. Date: Sep. 2, 2010

(54) WATER SOFTENER

(76) Inventor: Seung Hoon Jeong, Seoul (KR)

Correspondence Address: RABIN & Berdo, PC, 1101 14TH STREET, NW, SUITE 500, WASHINGTON, DC, 20005, US

(21) Appl. No.: 12/161,759

(22) PCT Filed: Nov. 14, 2006
(86) PCT No.: PCT/KR06/04787

§ 371 Date: Jul. 22, 2008

(30) Foreign Application Priority Data
Feb. 2, 2006 (KR) 10-2006-0010216
Feb. 2, 2006 (KR) 10-2006-0010217
Sep. 18, 2006 (KR) 10-2006-0090096

(51) Int. Cl. C02F 5/00

(52) U.S. Cl. 700/271

(57) ABSTRACT

Disclosed is a water softener, which is operable in a soft water mode in which cold/hot raw water is changed into cold/hot soft water using an ion exchange resin, a running water mode in which cold/hot running water as the cold/hot raw water is discharged, a regeneration mode in which regenerated water is generated by a regeneration material and regeneration waste water generated in regeneration of the ion exchange resin is discharged, and a control mode in which supply of cold/hot raw water is controlled. The water softener comprises: a tank part comprising first and second soft water tanks filled with the ion exchange resin and a regeneration tank connected to the first and second soft water tanks and filled with the regeneration material; and a switch valve part comprising a first valve assembly connected to the first and second soft water tanks and the regeneration tank, first and second raw water supply pipelines to which the cold/hot raw water is supplied being connected to the first valve assembly, and a second valve assembly connected to the first and second soft water tanks and the first valve assembly, a discharge pipeline from which the cold/hot soft water and the cold/hot running water are discharged and a regeneration waste water pipeline from which the regeneration waste water is discharged being connected to the second valve assembly. The water softener has four special modes in addition to the above four basic modes. With this configuration, users can use and manage the water softener at their most convenience.

### TECHNICAL FIELD

The present invention relates to a water softener, and more particularly, to a water softener, which is operable in \textcircled{1} a soft water mode in which cold/hot raw water is changed into cold/hot soft water using an ion exchange resin, \textcircled{2} a running water mode in which cold/hot running water as the cold/hot raw water is discharged, \textcircled{3} a regeneration mode in which regenerated water is generated by a regeneration material and regeneration waste water generated in regeneration of an ion exchange resin is discharged, and \textcircled{4} a control mode in which supply of cold/hot raw water is controlled.

### BACKGROUND ART

Living water used in our daily life may be classified into soft water (also called sweet water) and hard water. Soft water, such as distilled water, has hydrogen (H₂) and oxygen (O₂) as its main components, being relatively pure, and is low in hardness, while hard water, such as underground water, has calcium ions (Ca²⁺) and magnesium ions (Mg²⁺) as its main components and is high in hardness.

Tap water supplied to most of houses is hard water with high hardness and contains not only chlorine (Cl) used in the process of purification of the tap water but also much heavy metal ions, such as iron (Fe) ions, copper (Cu) ions, tin (Sn) ions, zinc (Zn) ions, mercury (Hg) ions and so on, which may be produced due to environment pollution and deterioration of water pipes. Although such heavy metal ions are not lethal to a human body, it is known that alien metal substances are produced when heavy metal ions are combined with fatty acid of soap, which are responsible for accelerated skin-aging and skin diseases such as atopy.

Under such circumstances, a water softener has been introduced to change such hard water as tap water into soft water and is being widely used as the most convenient method of obtaining living water of high quality in houses, offices and so on.

The principle of a water softener to change hard water into soft water is to substitute calcium ions (Ca²⁺) and magnesium ions (Mg²⁺) contained in hard water with sodium ions (Na⁺). For this substitution, an ion exchange resin comprising a special polymer compound containing sodium (Na) as its main component is used. The ion exchange resin discharges sodium ions (Na⁺), instead of absorbing calcium ions (Ca²⁺) and magnesium ions (Mg²⁺), when the ion exchange resin contacts the hard water. Therefore, a soft water tank, which is filled with ion exchange resin and into which hard water is introduced to obtain soft water, is indispensable to the water softener.

With repeated softening of hard water into soft water, sodium ions (Na⁺) of the ion exchange resin is exhausted, thereby deteriorating its capacity of water softening. Therefore, as a separate regeneration material to recover the softening capacity of the ion exchange resin, salt or the like, which is injected and stored in a regeneration tank connected to the soft water tank, is used to generate sodium ions (Na⁺) in an aqueous solution. When hard water is fed into the regeneration tank, regenerated water such as salt water containing sodium ions (Na⁺) is produced and fed into the soft water tank. The regenerated water recovers the softening capacity of the ion exchange resin and then is discharged as regeneration waste water.

FIG. 1 is a block diagram of a general water softener, particularly, a cold/hot water softener that discharges cold/hot soft water softened differently depending on temperature of hard water. In the following description, a water softener refers to a cold/hot water softener, and hard water such as tap water fed into the water softener is called raw water, which will be consistently used throughout the specification.

As shown in FIG. 1, a general water softener comprises first and second soft water tanks 12 and 14, first and second regeneration tanks 22 and 24, a plurality of pipelines 31 to 38, and a plurality of valves V1 to V7.

The first and second soft water tanks 12 and 14 are filled with ion exchange resin, and regeneration material is injected into the first and second regeneration tanks 22 and 24.

The plurality of pipelines 31 to 38 includes first and second tank feed pipes 31 and 32 through which cold/hot raw water is fed into the first and second soft water tanks 12 and 14 externally, first and second tank discharge pipes 33 and 34 through which liquid, for example, cold/hot soft water or regeneration waster water, inside the first and second soft water tanks 12 and 14 is discharged, first and second regeneration raw water pipes 35 and 36 through which raw water is fed into the first and second regeneration tanks 22 and 24, and first and second regenerated water pipes 37 and 38 through which regenerated water produced in the first and second regeneration tanks 22 and 24 is fed into the first and second soft water tanks 12 and 14, respectively. The plurality of valves V1 to V7 are disposed at proper positions in these pipelines 31 to 38.

When the first and second valves V1 and V2 of the first and second tank feed pipes 31 and 32 are opened to fed the cold/hot raw water into the first and second soft water tanks 12 and 14, the cold/hot soft water is produced by an ion exchange action of the ion exchange resin. When the third valve V3 interconnecting the first and second tank discharge pipes 33 and 34 is opened, the cold/hot soft water is discharged. In addition, for regeneration of the ion exchange resin exhausted due to repeated water softening, when the fourth and fifth valves V4 and V5 of the first and second regeneration raw water pipes 35 and 36 are opened to fed the raw water into the first and second regeneration tanks 22 and 24, regenerated water containing sodium ions (Na⁺) is produced. When the sixth and seventh valves V6 and V7 of the first and second regenerated water pipes 37 and 38 are opened to fed the regenerated water into the first and second soft water tanks 12 and 14, the ion exchange resin is recovered, and then the third valve V3 interconnecting the first and second tank discharge pipes 33 and 34 is opened to discharge regeneration waster water.

However, the above-described general water softener has several demerits as follows.

First, since there is no measure to precisely determine a regeneration time of the ion exchange resin, the determination on the regeneration time depends entirely on a user's subjective feeling or rough time calculation. This may result in wastefulness of regeneration material due to frequent unnecessary regeneration, or deterioration of performance and lifetime of the ion exchange resin due to missing of a proper regeneration chance.

Second, a regeneration method of the ion exchange resin is too complicated, which requires even a skilled worker to take a long work time to regenerate the ion exchange resin. Particularly, there is troublesomeness in that a user has to directly operate the plurality of valves V1 to V7 whenever the ion exchange resin is regenerated. Accordingly, not only it is difficult for the user to use the water softener, but also there is a possibility of malfunction or failure of the water softener due to mistaken operation of an inexperienced user.

Third, since the temperature of the cold/hot soft water stored in the first and second soft water tanks 12 and 14 varies with time, it takes a long time to obtain soft water at an aimed temperature. In other words, the cold/hot soft water stored in the first and second soft water tanks 12 and 14 of the general water softener gets cold or hot with time, and therefore, even when the second and third valves V2 and V3 are opened to use hot soft water, soft water of a temperature lower than the aim temperature may be discharged for some time, and, conversely, even when the first and third valves V1 and V3 are opened to use cold soft water, soft water of a temperature higher than the aim temperature may be discharged for some time. This may make the user uncomfortable. In addition, since soft water is wastefully flown out until the soft water reaches the aim temperature, water resources are wasteful, a regeneration cycle of the ion exchange resin is shortened and the lifetime of the water softener is lowered.

Furthermore, the general water softener requires a large installation area, thereby lowering space utilization.

### DISCLOSURE OF INVENTION

### Technical Problem

To overcome the above problems, it is an object of the present invention to provide a water softener, which is capable of precisely determining a regeneration time of an ion exchange resin and regenerating the ion exchange resin more simply and conveniently.

It is another object of the present invention to provide a water softener, which is capable of allowing a user to adjust and discharge cold/hot soft water or cold/hot running water at an aimed temperature quickly and precisely, in particular, allowing any users to use the water softener simply.

It is still another object of the present invention to provide a water softener with good space efficiency since it can be placed in a narrow space such as a corner in a bathroom or the like, further allowing users to use and manage the water softener at their most convenience.

### Technical Solution

To achieve the above objects, the present invention provides a water softener, which is operable in a soft water mode in which cold/hot raw water is changed into cold/hot soft water using an ion exchange resin, a running water mode in which cold/hot running water as the cold/hot raw water is discharged, a regeneration mode in which regenerated water is generated by a regeneration material and regeneration waste water generated in regeneration of the ion exchange resin is discharged, and a control mode in which supply of cold/hot raw water is controlled, comprising: a tank part comprising first and second soft water tanks filled with the ion exchange resin and a regeneration tank connected to the first and second soft water tanks and filled with the regeneration material; and a switch valve part comprising a first valve assembly connected to the first and second soft water tanks and the regeneration tank, first and second raw water supply pipelines to which the cold/hot raw water is supplied being connected to the first valve assembly, and a second valve assembly connected to the first and second soft water tanks and the first valve assembly, a discharge pipeline from which the cold/hot soft water and the cold/hot running water are discharged and a regeneration waste water pipeline from which the regeneration waste water is discharged being connected to the second valve assembly, and the first valve assembly transfers the cold/hot raw water of the first and second raw water supply pipelines to the first and second soft water tanks and the second valve assembly discharges the cold/hot soft water of the first and second soft water tanks to the discharge pipeline in the soft water mode, the first valve assembly transfers the cold/hot raw water of the first and second raw water supply pipelines to the second valve assembly and the second valve assembly discharges the cold/hot running water as the cold/hot raw water to the discharge pipeline in the running water mode, the first valve assembly transfers the cold/hot raw water of the first and second raw water supply pipelines to the regeneration tank and the second valve assembly discharges the regeneration waste water of the first and second soft water tanks to the regeneration waste water pipeline in the regeneration mode, and the first valve assembly controls the first and second raw water supply pipelines in the control mode.

Preferably, the water softener further comprises a main body in which the tank part is mounted and the switch valve is incorporated, the main body comprises: a cover plate in which the tank part is mounted; a middle plate adhered closely to the bottom of the cover plate; a bottom plate adhered closely to the bottom of the middle plate; and a bottom case that accommodates the switch valve part and is combined to the bottom of the middle plate. Two selected from the cover plate, the middle plate and the bottom plate are welded by vibration.

Preferably, the bottom plate is formed with first and second bottom holes connected to the first and second raw water supply pipelines, respectively, the cover plate is formed with first and second cover holes that are connected to the first and second soft water tanks, respectively, and supply the cold/hot raw water, a third cover hole that is connected to the regeneration tank and supplies the regeneration raw water, a fourth cover hole that is connected to the discharge pipeline and discharges the cold/hot soft water and the cold/hot running water, and first and second discharge holes that are connected to the first and second soft water tanks, respectively, and discharge the cold/hot soft water and the regeneration waste water, the middle plate is formed with a plurality of first and second disk holes and a first middle hole connected to the regeneration waste water pipeline, one or more of the plurality of first disk holes being connected to two selected from the plurality of second disk holes, the first and second bottom holes, and the first to third cover holes, respectively, and one or more of the plurality of second disk holes being connected to the first middle hole and the fourth cover hole, respectively, and the first and second valve assemblies interconnect two or more selected from the first and second disk holes for each of the modes, respectively. The first valve assembly comprises: a first fixing disk that is adhered closely to the bottom of the middle plate and is formed with a plurality of first fixing holes connected to ones selected from the first disk holes, respectively, along an edge of the middle plate; and a first rotating disk that is adhered closely to the bottom of the first fixing disk and is formed with one or more first rotating passages interconnecting two or more selected from the plurality of first fixing holes for each of the modes by rotation of the first rotating disk, and the second valve assembly comprises: a second fixing disk that is adhered closely to the bottom of the middle plate and is formed with a plurality of second fixing holes connected to ones selected from the second disk holes, respectively, along an edge of the middle plate; and a second rotating disk that is adhered closely to the bottom of the second fixing disk and is formed with one or more second rotating passages interconnecting two or more selected from the plurality of second fixing holes for each of the modes by rotation of the second rotating disk.

Preferably, the water softener further comprises a plurality of oil grooves formed in the bottom of at least one selected from the first and second rotating disks, oil for lubrication and watertight being stored in the oil grooves. The plurality of first disk holes comprises one or more 1st-1 disk holes connected to the first bottom hole, one or more 1st-2 disk holes connected to the second bottom hole, one or more 1st-3 disk holes connected to the first cover hole, one or more 1st-4 disk holes connected to the second cover hole, one or more 1st-5 disk holes connected to the third cover hole, and one or more 1st-6 and 1st-7 disk holes connected to two selected from the second disk holes, respectively, and the plurality of second disk holes comprises one or more 2nd-1 disk holes connected to the first discharge hole, one or more 2nd-2 disk holes connected to the second discharge hole, one or more 2nd-3 disk holes connected to the first middle hole, and one or more 2nd-4 disk holes connected to the fourth cover hole. The plurality of first fixing holes comprises 1st-1 and 1st-2 fixing holes connected to the 1st-1 disk hole, 1st-3 to 1st-5 fixing holes connected to the 1st-2 disk hole, a 1st-6 fixing hole connected to the 1st-3 disk hole, a 1st-7 fixing hole connected to the 1st-4 disk hole, a 1st-8 fixing hole connected to the 1st-5 disk hole, a 1st-9 fixing hole connected to the 1st-6 disk hole, and a 1st-10 fixing hole connected to the 1st-7 disk hole, and the plurality of second fixing holes comprises a 2nd-1 fixing hole connected to the 2nd-1 disk hole, a 2nd-2 fixing hole connected to the 2nd-2 disk hole, a 2nd-3 fixing hole connected to the 2nd-3 disk hole, and a 2nd-4 fixing hole connected to the 2nd-4 disk hole. The 1st-8 fixing hole has a diameter smaller than diameters of first fixing holes other than the 1st-8 fixing hole. The diameter of the 1st-8 fixing hole is 0.5 to 2 mm.

Preferably, the middle plate is further formed with second and third middle hole, a first bottom passage interconnecting the first bottom hole and the second middle hole and a second bottom passage interconnecting the second bottom hole and the third middle hole are defined between the middle plate and the bottom plate, and a first cover passage interconnecting the second middle hole and the 1st-1 disk hole, a second cover passage interconnecting the third middle hole and the 1st-2 disk hole, a third cover passage interconnecting the first cover hole and the 1st-3 disk hole, a fourth cover passage interconnecting the second cover hole and the 1st-4 disk hole, a fifth cover passage interconnecting the third cover hole and the 1st-5 disk hole, a sixth cover passage interconnecting the fourth cover hole and the 2nd-4 disk hole, a first discharge passage interconnecting the first discharge hole, the 2nd-1 disk hole and the 1st-7 disk hole, and a second discharge passage interconnecting the second discharge hole, the 1st-6 disk hole and the 2nd-2 disk hole. The water softener further comprises a distribution passage defined between the middle plate and the first fixing disks and connecting the 1st-1 disk hole to the 1st-1 and 1st-2 fixing holes.

Preferably, the 1st-3 fixing hole is located in a 6 o'clock direction, the 1st-7, 1st-2, 1st-8 and 1st-4 fixing holes are located in 5, 4, 3 and 2 o'clock directions, respectively, and the 1st-6, 1st-1, 1st-9, 1st-5 and 1st-10 fixing holes are located in 7, 8, 9, 10 and 11 o'clock directions, respectively, and the first rotating passage comprises 1st-1 and 1st-2 rotating passages interconnecting positions of the fixing holes in two adjacent o'clock direction with an interval of one hour. The 1st-1 rotating passage interconnects the 1st-1 and 1st-6 fixing holes and the 1st-2 rotating passage interconnects the 1st-3 and 1st-7 fixing holes in the soft water mode, the 1st-1 rotating passage interconnects the 1st-10 and 1st-5 fixing holes and the 1st-2 rotating passage interconnects the 1st-9 and 1st-1 fixing holes in the running water mode, the 1st-1 rotating passage corresponds to the 1st-4 and the 1st-2 rotating passage interconnects the 1st-2 and 1st-8 fixing holes in the regeneration mode, and the 1st-1 rotating passage corresponds to the 1st-4 and the 1st-2 rotating passage corresponds to the 1st-10 fixing hole in the control mode. The 2nd-1 fixing hole is located in a 6 o'clock direction, and the 2nd-2, 2nd-3, and 2nd-4 fixing holes are located in 12, 3, and 9 o'clock directions, respectively, and the second rotating passage of the second rotating disk comprises a 2nd-1 rotating passage interconnecting the 2nd-1 fixing hole, the 2nd-2 fixing hole and the 2nd-4 fixing hole in the soft water mode and the running water mode and interconnecting the 2nd-1 fixing hole, the 2nd-3 fixing hole and the 2nd-4 fixing hole in the regeneration mode.

Preferably, the cover plate is formed with fifth and sixth cover holes, and the bottom plate is formed with third and fourth bottom holes connected to the fifth and sixth cover holes, respectively, and the water softener further comprises a control valve that is provided on the top of the cover plate and interconnects the fourth and fifth cover holes or the fourth and sixth cover holes, or seals the fourth cover hole. The water softener further comprises: a hydrant pipe extending the third bottom hole downward to penetrate the bottom case; a hydrant connected to an end of the hydrant pipe of the outside of the bottom case; a shower head pipe extending the fourth bottom hole downward to penetrate the bottom case; and a shower head connected to an end of the shower head pipe of the outside of the bottom case. The hydrant includes an ejection hole of a slit shape. The control valve comprises: a valve housing connected to the third to fifth cover holes; a valve plate that is provided in the valve housing and provides first to third connecting holes connected to the third to fifth cover holes, respectively; a valve rotating disk that is adhered closely to the valve plate and is formed with a valve passage that seals the first connecting hole or interconnects the first and second connecting holes or the first and third connecting holes by rotation of the valve rotating disk; a valve cover that is combined to the valve housing to accommodate the valve rotating disk; a shaft that is combined to the center of rotation of the valve rotating disk through the valve cover; and a handle that is formed with an end of the shaft. The handle is exposed to the front side of the tank part.

Preferably, the first and second soft water tanks have a cylinder shape located in the right and left of the front side facing a user, and the regeneration tank is located in the rear side between the first and second soft water tanks. The main body has a triangular prism shape whose width becomes small from the front side to the rear side. The regeneration tank has a triangular prism shape whose width becomes small from the front side to the rear side.

Preferably, the water softener further comprises a bar-shaped stand that projects the main body downward to adjust a height and supports a floor. The stand comprises: a support pipe that is fixed to the main body and has an inner surface with a first screw thread formed thereon; a screw pipe that is screwed to an end of the support pipe and has an outer surface with a second screw thread engaging with the first screw thread; and a pedestal that is made of rubber and is combined to an end of the screw pipe. The water softener further comprises an adjustable screw engaging with the screw pipe to support the support pipe.

Preferably, the water softener further comprises: a drain pipeline that discharges regenerated water in the regeneration tank; and a stop valve that opens/closes the drain pipeline. The cover plate is further formed with a fifth cover hole that is connected to the regeneration tank and discharges regenerated water in the regeneration tank, the middle plate is further formed with a second middle hole connected to the fifth cover hole, and the bottom plate is further formed with a third bottom hole connected to the second middle hole. The water softener further comprises: a drain pipe that extends the third bottom hole downward from the bottom of the bottom plate to penetrate the bottom case; and a stop valve formed at an end of the drain pipe of the outside of the bottom case.

Preferably, the water softener further comprises: a regeneration raw water pipe that extends the third cover hole from the top of the cover plate to be inserted in the bottom of the regeneration tank; and a drain connecting pipe that extends the fifth cover hole from the top of the cover plate to be inserted in the bottom of the regeneration tank. The water softener further comprises a rib formed along a longitudinal direction of outer surfaces of the regeneration raw water pipe and the drain connecting pipe.

Preferably, the water softener further comprises first and second motors that rotate the first and second rotating disks, respectively. The water softener further comprises a controller that switches the modes by controlling rotation of the first and second motors and includes an input unit for input of user's instructions and a display unit for display of data. The water softener further comprises first and second optical sensors that sense a degree of rotation of the first and second motors, respectively, wherein the controller controls the rotation of the first and second motors based on a result of sense of the first and second optical sensors.

Preferably, the water softener further comprises first and second measuring units that are provided in the first and second raw water supply pipelines, respectively, and measure the amount of supply of the cold/hot raw water. The first and second measuring units are mounted in the main body. The controller calculates the amount of flow of the cold/hot raw water supplied to the first and second soft water tanks through the first and second measuring units and performs the regeneration mode automatically at a regeneration cycle of the ion exchange resin based on the calculated amount of flow.

Preferably, the controller includes a timer and performs the regeneration mode at a specified time. The controller controls the amount of flow of the cold/hot soft water and the cold/hot running water discharged to the discharge pipeline by controlling a degree of rotation of the first motor based on a result of sense of the first and second measuring units.

Preferably, the water softener further comprises: first and second motors that rotate the first and second rotating disks, respectively; a temperature sensor that senses temperature of the cold/hot soft water and the cold/hot running water discharged to the discharge passage; and a controller that controls rotation of the first and second motors, and the controller controls a mixture ratio of the cold/hot soft water and the cold/hot running water through a relative degree of interconnection of the 2nd-1 and 2nd-4 fixing holes with respect to the 2nd-2 fixing hole by controlling rotation of the second motor based on a result of sense of the temperature sensor. The 2nd-1 fixing hole is branched to a first extending hole close to the 2nd-4 fixing hole and a second extending hole close to the 2nd-3 fixing hole via a 2nd-1 fixing groove formed on the second fixing disk, and the 2nd-2 fixing hole is branched to a third extending hole close to the 2nd-4 fixing hole and a fourth extending hole close to the 2nd-3 fixing hole via a 2nd-2 fixing groove formed on the second fixing disk, the first and third extending holes have a taper shape whose width decreases to the 2nd-2 fixing hole, and the 2nd-1 rotating passage interconnects portions of the 2nd-2 fixing hole and the first and third extending holes in the soft water mode and the running water mode.

Preferably, the water softener further comprises: first and second measuring units that are provided in the first and second raw water supply pipelines, respectively, and measure the amount of supply of the cold/hot raw water; first and second motors that rotate the first and second rotating disks, respectively; and a controller that controls rotation of the first and second motors, and the controller calculates the amount of flow of the cold/hot raw water supplied to the first and second soft water tanks through the first and second measuring units and exchanges the kind of the cold/hot raw water supplied to the first and second soft water tanks through rotation of the first motor when the amount of flow of the cold/hot raw water in one of the first and second soft water tanks are too larger than that in the other. The 1st-1 rotating passage interconnects the 1st-1 and 1st-6 fixing holes and the 1st-2 rotating passage interconnects the 1st-3 and 1st-7 fixing holes, or the 1st-1 rotating passage interconnects the 1st-6 and 1st-3 fixing holes and the 1st-2 rotating passage interconnects the 1st-7 and 1st-2 fixing holes in order to exchange the kind of the cold/hot raw water supplied to the first and second soft water tanks.

Preferably, the water softener further comprises: a lid plate that covers the top of the first and second soft water tanks and the regeneration tank and is formed with first and second valve holes connected to the first and second soft water tanks, respectively; a filter cover that is adhered closely to the top of the lid plate to cover the first and second valve holes and includes first and second valve housings connected to the first and second raw water supply pipelines, respectively; and first and second pre-filters that are mounted in the first and second valve holes, respectively. The first and second pre-filters include first and second valve assemblies of a cylinder shape, respectively. The first and second pre-filters further respectively comprises: first and second lower frames that are combined to the bottoms of the first and second valve assemblies, respectively, with a plurality of first and second through holes being formed thereon, the plurality of first and second through holes being connected to the inside of the first and second valve assemblies, respectively; and first and second upper frames that are combined to the tops of the first and second valve assemblies and are provided with grips, respectively. The water softener further comprises a plurality of first and second guides that project upward along circumferences of the first and second valve holes, with regular intervals between the plurality of first and second guides, and the cold/hot raw water is supplied into the first and second soft water tanks after impurities contained in the cold/hot raw water are filtered out while circling along outer sides of the first and second guides in the first and second valve housings and being introduced into the first and second valve assemblies, respectively. The water softener further comprises first and second distribution plates that face the bottoms of the first and second valve assemblies, with specified intervals therebetween, respectively, and cause the cold/hot raw water to spread and drop.

Preferably, the water softener further comprises: valve chambers that are provided in the lid plate and are connected to the first and second soft water tanks, respectively; and a regenerated water producing pipe that communicates to the valve chambers and projects downward from the bottom of the lid plate to be inserted in the regeneration tank. The water softener further comprises: first and second regenerated water holes that are formed in the lid plate to be connected to the first and second soft water tanks, respectively; and first and second regenerated water passages that are defined between the lid plate and the filter cover and connect the valve chambers to the first and second regenerated water holes, respectively. The water softener further comprises first and second regenerated water connecting pipes that are provided in the first and second soft water tanks, respectively, to extend the first and second regenerated water holes to the tops of first and second distribution plates. The water softener further comprises first and second regeneration check valves that are mounted in the valve chambers and are opened to only the first and second regenerated water passages, respectively. The first and second regeneration tanks cover the first and second discharge holes, respectively, and the water softener further comprises first and second check valves that are provided in the first and second regeneration tanks and are opened to only the first and second discharge holes, respectively.

Preferably, the water softener further comprises: first and second tank supply pipelines that interconnect the first valve assembly and the first and second soft water tanks, respectively, and transfer the cold/hot raw; first and second tank discharge pipelines that interconnect the first and second soft water tanks and the second valve assembly, respectively, and transfer the cold/hot soft water and the regeneration waste water; a regeneration raw water pipeline that interconnects the first valve assembly and the regeneration tank and transfers the regeneration raw water; first and second regenerated water pipelines that interconnect the regeneration tank and the first and second soft water tanks, respectively, and transfer the regenerated water; and first and second raw water transfer pipelines that interconnect the first and second valve assemblies, respectively, and transfer the cold/hot raw water, and the first valve assembly interconnects the first and second raw water supply pipelines and the first and second tank supply pipelines and the second valve assembly interconnects the first and second tank discharge pipelines and the discharge pipeline in the soft water mode, the first valve assembly interconnects the first and second raw water supply pipelines and the first and second raw water transfer pipelines and the second valve assembly interconnects the first and second raw water transfer pipelines and the discharge pipeline in the running water mode, the first valve assembly interconnects the first or second raw water supply pipeline and the regeneration raw water pipeline and the second valve assembly interconnects the first and second tank discharge pipelines and the regeneration waste water pipeline in the regeneration mode, and the first valve assembly controls the first and second raw water supply pipelines in the control mode.

### ADVANTAGEOUS EFFECTS

According to the present invention, the water softener has an advantage of selecting and using any of the four basic modes; the soft water mode, the running water mode, the regeneration mode, and the control mode easily and conveniently. Accordingly, any user can use the water softener conveniently and safely without requiring any special knowledge or efforts for regeneration of ion exchange resin.

As the four special modes in addition to the four basic modes, the water softener has other advantages as follows: first, it is possible to prolong the lifetime of the ion exchange resin of the first and second soft water tank and obtain maximum capability of softening of the ion exchange resin through the cold/hot change mode, second, it is possible to perform the regeneration automatically at an exact time without any user's intervention through the automatic regeneration mode, which results in significant reduction of time and efforts, third, it is possible to use water of intended temperature quickly through the temperature regulation mode, and fourth, it is possible to automatically control the kind and discharge amount of water through the flow regulation mode.

Furthermore, the water softener has an advantage of good space efficiency since it can be placed in a corner at which two walls intersect with each other in a bathroom or the like.

### BRIEF DESCRIPTION OF THE DRAWINGS

FIG. 1 is a block diagram of a general water softener.

FIG. 2 is a block diagram of a water softener according to an embodiment of the present invention.

FIGS. 3 and 4 are front and rear side perspective views of the water softener according to the embodiment of the present invention, respectively.

FIGS. 5 and 6 are a perspective view and an exploded perspective view of a main body of the water softener according to the embodiment of the present invention.

FIG. 7 is a plan view of a bottom case of the main body of the water softener according to the embodiment of the present invention.

FIG. 8 is a plan view of a bottom plate of the main body of the water softener according to the embodiment of the present invention.

FIGS. 9 and 10 are a plan view and a bottom view of a middle plate of the main body of the water softener according to the embodiment of the present invention, respectively.

FIGS. 11 and 12 are a plan view and a bottom view of a cover plate of the main body of the water softener according to the embodiment of the present invention, respectively.

FIG. 13 is an exploded perspective view of a switch valve part of the main body of the water softener according to the embodiment of the present invention.

FIGS. 14 and 15 are a plan view and a bottom view of a first fixed disk of the switch valve part of the main body of the water softener according to the embodiment of the present invention, respectively.

FIG. 16 is a plan view of a first rotating disk of the switch valve part of the main body of the water softener according to the embodiment of the present invention.

FIGS. 17 and 18 are a plan view and a bottom view of a second fixed disk of the switch valve part of the main body of the water softener according to the embodiment of the present invention, respectively.

FIG. 19 is a plan view of a second rotating disk of the switch valve part of the main body of the water softener according to the embodiment of the present invention.

FIGS. 20 to 24 are schematic views illustrating operation modes of the water softener according to the embodiment of the present invention.

FIG. 25 is an exploded rear side perspective view of a portion of a tank part of the water softener according to the embodiment of the present invention.

FIG. 26 is a sectional view of a portion of the tank part of the water softener according to the embodiment of the present invention.

FIG. 27 is a bottom view of a filter cover of the tank part of the water softener according to the embodiment of the present invention.

FIG. 28 is an exploded perspective view of the main body and the switch valve part of the water softener according to the embodiment of the present invention.

FIG. 29 is a block diagram of a controller of the water softener according to the embodiment of the present invention.

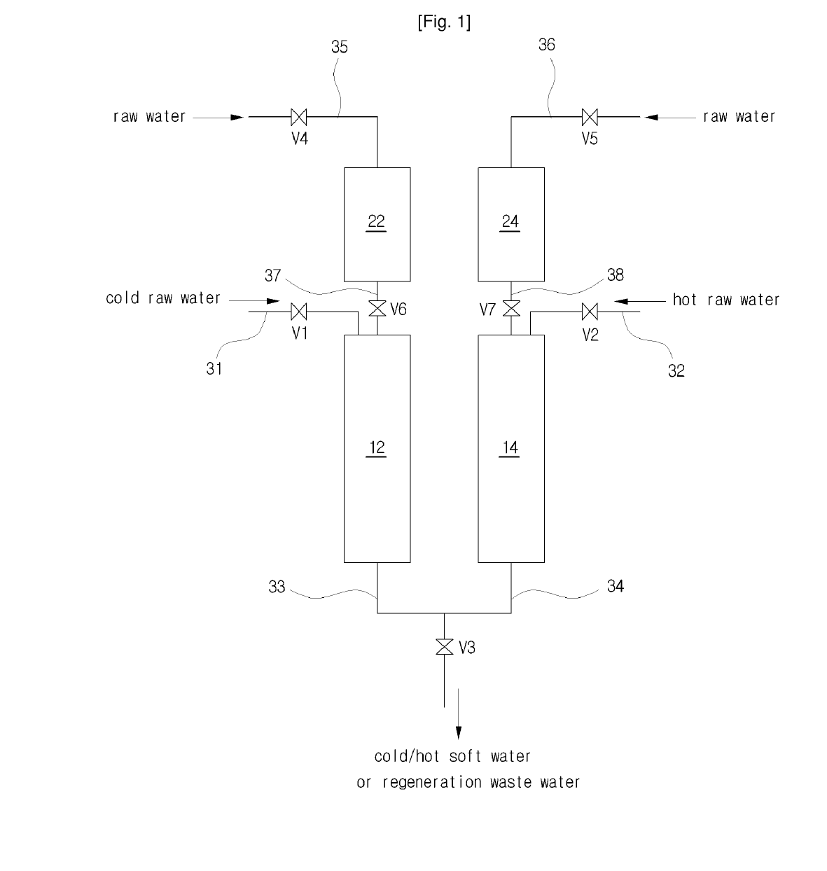

### MODE FOR THE INVENTION

Hereinafter, a water softener according to an exemplary embodiment of the present invention will be described with reference to the accompanying drawings.

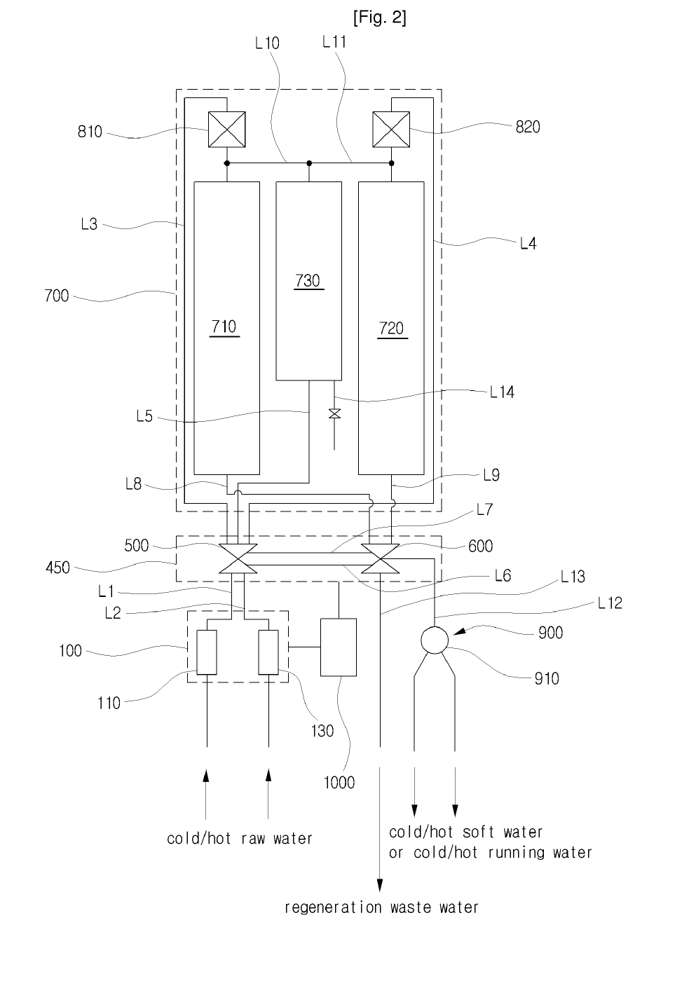

FIG. 2 is a block diagram showing an outline of a water softener according to an embodiment of the present invention. As shown in FIG. 2, the water softener comprises a supplying part 100, a switch valve part 450, a tank part 700, a discharging part 900, a controller 1000, and a plurality of pipelines L1 to L14.

The supplying part 100 is a part to which cold/hot raw water is first supplied externally, and comprises first and second measuring units 110 and 130 that measure the amount of flow of the cold/hot raw water, respectively. The switch valve part 450 determines and controls a moving path of liquid in the water softener, for example, cold/hot raw water, cold/hot soft water, cold/hot running water, regenerated water, regeneration waste water, etc., and comprises first and second valve assemblies 500 and 600. The tank part 700 comprises two first and second soft water tanks 710 and 720 which are filled with ion exchange resin, and a regeneration tank 730 which is filled with regeneration material. When the cold/hot raw water is supplied to the first and second soft water tanks 710 and 720, the cold/hot soft water is discharged therefrom. When the regenerated water is supplied to the first and second soft water tanks 710 and 720, the regeneration waste is discharged therefrom. When the cold/hot raw water is supplied to the regeneration tank 730, the regenerated water is discharged therefrom. The discharging part 900 discharges or finally controls the cold/hot soft water or the cold/hot running water to be supplied to a user, and comprises a control valve 910 to be directly controlled by the user, a hydrant, a shower head, etc. The controller 1000 controls the switch valve part 450 to determine an operation mode of the water softener according to a use purpose of the user, and comprises a logic circuit having a predetermined algorithm, an input unit for input of instructions from the user, a display unit for display of data, etc.

The plurality of pipelines L1 to L14 provided in the water softener comprises first and second raw water supplying pipelines L1 and L2 that supply the cold/hot raw water, which is first supplied to the first and second measuring units 110 and 130 of the supplying part 100, to the first valve assembly 500 of the switch valve part 450, first and second tank supply pipelines L3 and L4 that supply the cold/hot raw water of the first valve assembly 500 to the first and second soft water tanks 710 and 720, a regeneration raw water pipeline L5 that supplies the cold/hot raw water of the first valve assembly 500 to the regeneration tank 730, first and second raw water transfer pipelines L6 and L7 that transfer the cold/hot raw water of the first valve assembly 500 to the second valve assembly 600, first and second tank discharge pipelines L8 and L9 that transfer the liquid in the first and second soft water tanks 710 and 720, for example, cold/hot soft water and regeneration waste water, to the second valve assembly 60, first and second regenerated water pipelines L10 and L11 that transfer the regenerated water in the regeneration tank 730 to the first and second soft tanks 710 and 720, a discharge pipeline L12 that transfers the cold/hot soft water or cold/hot raw water of the second valve assembly 600 to the discharging part 900, a regeneration waste water pipeline L13 that discharges the regeneration waste water of the second valve assembly 600 to the outside, and a drain pipeline L14 that forcedly discharges residual regenerated liquid in the regeneration tank 730. On the first and second tank supply pipelines L3 and L4 may be provided first and second pre-filters 810 and 820 that filter impurities out of the cold/hot raw water supplied to the first and second soft water tanks 710 and 720, respectively.

Accordingly, the first and second valve assemblies 500 and 600 of the switch valve part 450 interconnect respective connected pipelines to determine and control moving paths of all liquid in the water softener, and thus, the water softener of the present invention has four basic modes and four special modes.

First, the four basic modes, which are most frequently used, include \textcircled{1} a soft water mode in which cold/hot raw water is discharged, \textcircled{2} a running water mode in which cold/hot raw water is discharged, \textcircled{3} a regeneration mode in which regeneration waster water generated in regeneration of an ion exchange resin is discharged, and \textcircled{4} a control mode in which supply and discharge of cold/hot raw water, cold/hot running water and regeneration waste water are controlled.

In the soft water mode, the cold/hot raw water of the first and second raw water supply pipelines L1 and L2 is supplied to the first and second soft water tanks 710 and 720 by the first valve assembly 500 via the first and second tank supply pipelines L3 and L4, and the cold/hot soft water of the first and second tank discharge pipelines L8 and L9, which is discharged from the first and second soft water tanks 710 and 720, is finally discharged to the outside by the second valve assembly 600 via the discharge pipeline L12 and the discharging part 900.

In the running water mode, the cold/hot raw water of the first and second raw water supply pipelines L1 and L2 is supplied to the second valve assembly 600 by the first valve assembly 500 via the first and second raw water transfer pipelines L6 and L7, and then is finally discharged to the outside by the second valve assembly 600 via the discharge pipeline L12 and the discharging part 900.

In the regeneration mode, the raw water of the first or second raw water supply pipeline L1 or L2 is supplied to the regeneration tank 730 by the first valve assembly 500 via the regeneration raw water pipeline L5, the regenerated water generated in the regeneration tank 730 is supplied to the first and second soft water tanks 710 and 720 via the first and second regenerated water pipelines L10 and L11, and the regeneration waste water of the first and second tank discharge pipelines L8 and L9, which is discharged from the first and second soft water tanks 710 and 720, is finally discharged to the outside by the second valve assembly 600 via the regeneration waste water pipeline L13.

Lastly, in the control mode, supply of the cold/hot raw water of the first and second raw water supply pipelines L1 and L2 is controlled by the first valve assembly 500.

As can be seen from the above, the first valve assembly 500 plays a role of ‘supply control’ to selectively supply or control the cold/hot raw water of the first and second raw water supply pipelines L1 and L2 to one of the first and second soft water tanks 710 and 720, the regeneration tank 730 and the second valve assembly 600, and the second valve assembly 600 plays a role of ‘discharge control’ to discharge the cold/hot raw water or the cold/hot soft water transferred via the first and second raw water transfer pipelines L6 and L7 or the first and second tank discharge pipelines L8 and L9 to the discharge pipeline L12 or discharge the regeneration waste water transferred via the first and second tank discharge pipelines L8 and L9 to the regeneration waste water pipeline L13.

Next, the four special modes, which are unique functions of the water softener of the present invention, include \textcircled{5} a cold/hot change mode in which the cold/hot raw water supplied to the first and second soft water tanks 710 and 720 is mutually changed based on the actual amount of use of the cold/hot soft water to uniformly adjust the softening capability of the ion exchange resin, \textcircled{6} an automatic regeneration mode in which a regeneration time of the ion exchange resin is exactly detected based on the actual amount of use of the cold/hot soft water, and accordingly, regeneration is automatically performed, \textcircled{7} a temperature regulation mode in which a mixture ratio of finally-discharged cold/hot soft water is controlled based on the temperature of the cold/hot soft water to thereby make the temperature equal to a temperature desired by a user, and \textcircled{8} a flow regulation mode in which the soft water mode or the running water mode is automatically changed to the control mode according to intention of the user to control the amount of discharge of the cold/hot soft water or the cold/hot running water.

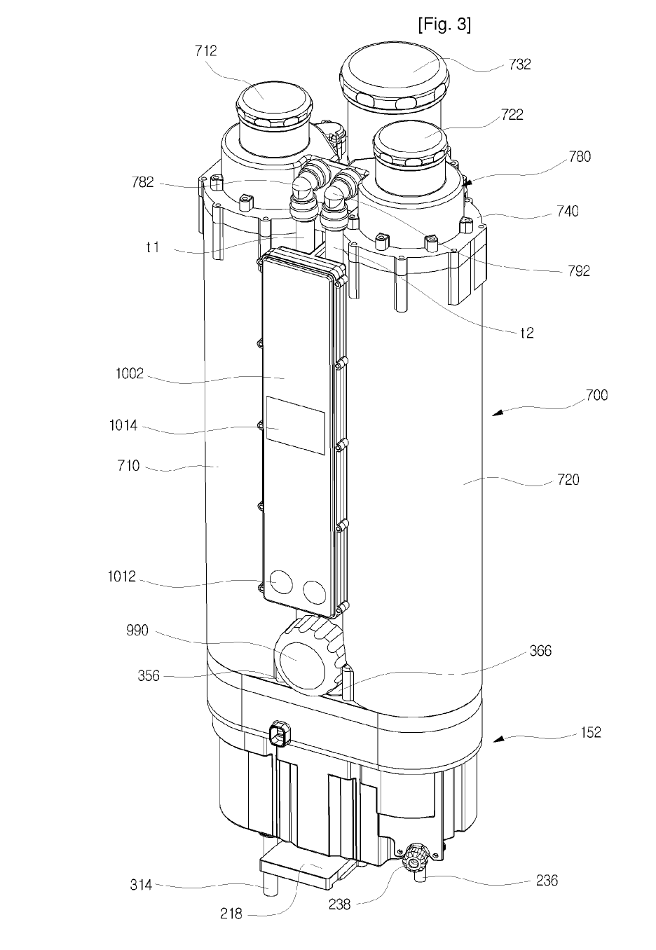

Hereinafter, the configuration of the water softener according to preferred embodiments of the present invention will be described in detail with reference to FIGS. 3 to 29. Throughout the accompanying drawings, the like elements are denoted by the like reference numerals. In the above description, moving paths of liquid are generally called ‘pipeline’ but may have the form of a tube or a passage properly defined in the water softener, which will be described in detail in relevant portions of the description.

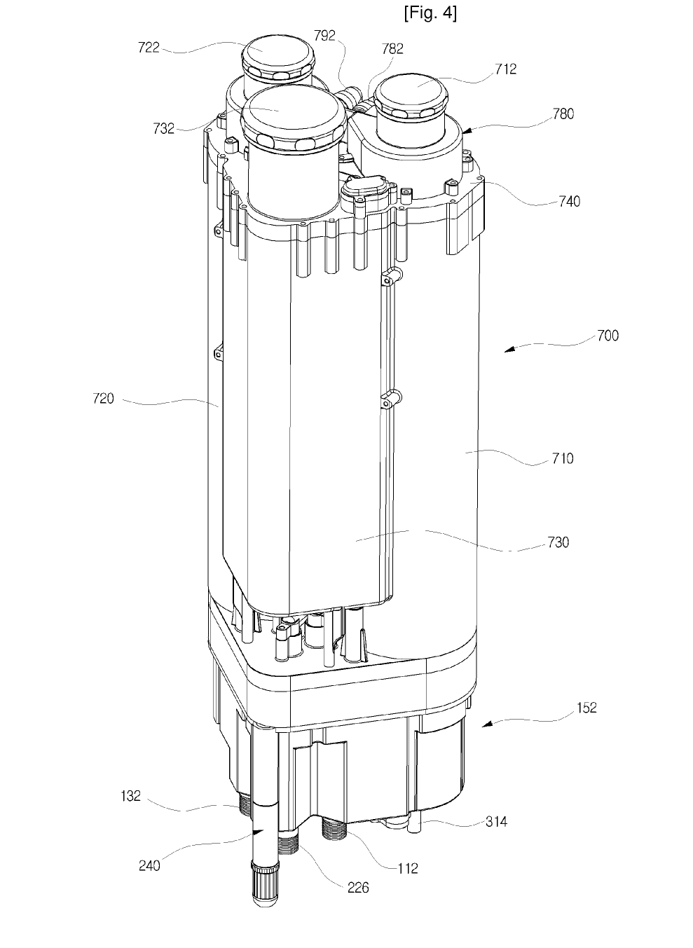

FIGS. 3 and 4 are front and rear side perspective views of the water softener according to an embodiment of the present invention, respectively, where an external case is not shown for convenience of description.

The water softener generally comprises a main body 152 and a tank part 700 mounted on the main body 152.

The main body 152 accommodates the supplying part 100, the switch valve part 450 and all or some of the discharging part 900 and provides a plurality of passages, which will be described later. The main body 152 has the form of a triangular prism whose width becomes small from the front to the rear. First and second water inlet pipes 112 and 132 of the first and second measuring units 110 and 130 to which external cold/hot water pipes are respectively connected, a shower head pipe 226 to which a hydrant 218 and a shower head of the discharging part 900 are connected, a regeneration waste water pipe 314, and a drain pipe 236 project from the bottom of the main body 152, and first and second supply ports 356 and 366 project from the top of the main body 152.

The first and second soft water tanks 710 and 720 of the tank part 700 are disposed right and left in the front side and have a cylindrical shape, and the regeneration tank 730 is located at the rear side between the first and second soft water tanks 710 and 720.

Top sides of the first and second soft water tanks 710 and 720 and the regeneration tank 730 are covered and sealed with a lid plate 740. On a portion of the lid plate 740 corresponding to the regeneration tank 730 is opened with a regeneration tank stopper 732 to inject and refill regeneration material, and portions of the lid plate 740 corresponding to the first and second soft water tanks 710 and 720 are covered with filter covers 780 opened with first and second filter stoppers 712 and 722, respectively. The filter covers 780 are provided with third and fourth supply ports 782 and 792 to supply cold/hot raw water to the first and second soft water tanks 710 and 720, respectively. The first and second supply ports 356 and 366 on the top of the main body 152 are connected to the third and fourth supply ports 782 and 792 of the filter covers 780 via first and second tubes t1 and t2, respectively.

As shown in the figures, the regeneration tank 730 has the form of a triangular prism whose width becomes small from the front to the rear. As a result, the water softener including the main body 152 has the form of a substantially triangular prism.

The reason why the water softener has the form of a triangular shape is that the water softener is placed in a corner at which two walls intersect with each other in a bathroom. In this case, it is preferable that a bar-shaped stand 240 bearing the weight of the water softener projects from the bottom of the main body 152 to support the floor of the bathroom. In addition, one or more brackets may be provided in an external case (not shown) to fix the water softener on a wall of the bathroom by use of a nail or the like. Thus, the water softener may be stably fixed as the stand 240 supports the floor with the water softener suspended over the corner by the bracket. Accordingly, as the main body 152 rises from the floor at a predetermined distance, the first and second water inlet pipes 112 and 132 and the shower head pipe 226 projecting from the bottom of the main body 152 can be easily connected to the cold/hot water pipe and the shower head, respectively.

In addition, the control valve 910 of the discharging part 900 is provided on the top of the main body 152 between the first and second soft water tanks 710 and 720 to expose a handle 990 between the first and second soft water tanks 710 and 720. In addition, a controller case 1002 accommodating the controller 1000 is provided at the front side between the first and second soft water tanks 710 and 720. The controller case 1002 has a printed circuit board on which a logic circuit is mounted, an input unit 1012 provided with buttons and dials, a display unit 1014 such as a liquid crystal display, etc.

In this case, the handle 990 and the input unit 1012 and the display unit 1014 of the controller case 1002 are exposed to a user.

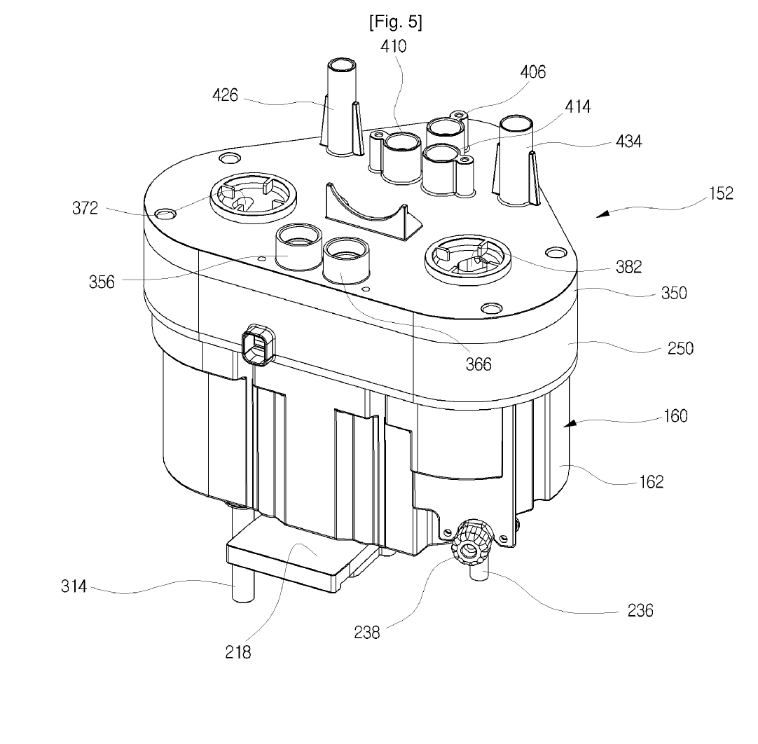

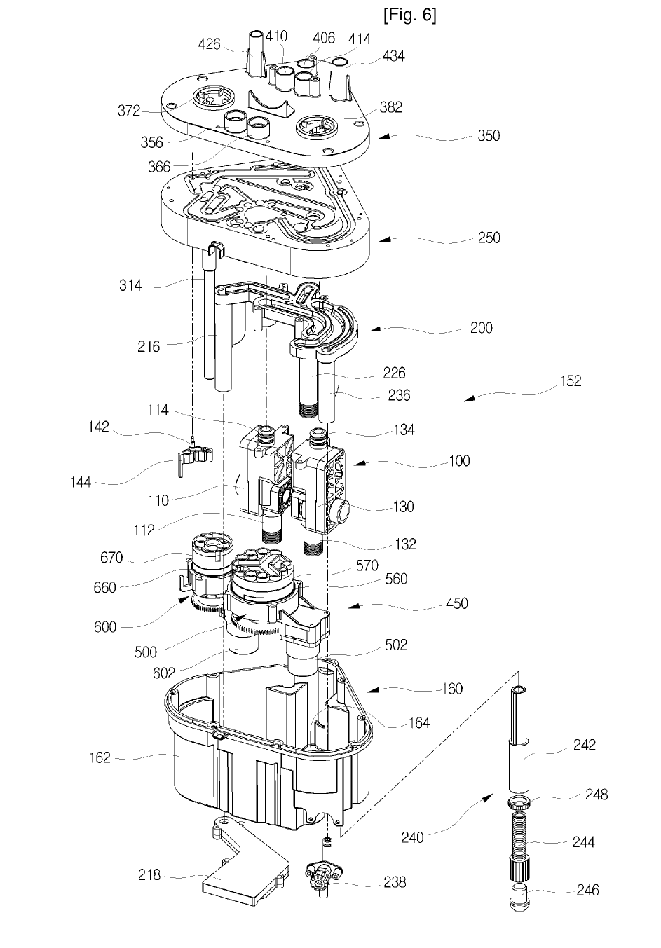

Now, details of the main body 152 will be described with reference to FIGS. 5 and 6 in conjunction with FIGS. 3 and 4. FIGS. 5 and 6 are a perspective view and an exploded perspective view of the main body 152, respectively. As described earlier, the main body 152 of the water softener supports the tank part 700, accommodates the supplying part 100, the switch valve part 450 and all or some of the discharging part 900, and particularly provides the plurality of passages as moving paths of liquid.

To the end, the main body 152 generally comprises a chest-shaped bottom case 160 comprising a side 162 of a predetermined height and a bottom 164, with its top opened, a middle plate 250 covering the top of the bottom case 160, and a cover plate 350 combined closely to the top of the middle plate 250 and on which the tank part is assembled. In the internal space defined by the bottom case 160 and the middle plate 250 are mounted a bottom plate 200 attached closely to the bottom of the middle plate 250, the first and second measuring units 110 and 130 of the supplying part 100, and the first and second valve assemblies 500 and 600 of the switch valve part 450.

The first and second water inlet pipes 112 and 132 project from the bottom of the first and second measuring units 110 and 130 and pass through the bottom 164 of the bottom case 160 to be connected to the cold/hot water pipes, and first and second water outlet pipes 114 and 134 inserted into the bottom plate 200 project from the top of the first and second measuring units 110 and 130. Accordingly, the cold/hot raw water supplied to the first and second water inlet pipes 112 and 132 is transferred to the first and second water outlet pipes 114 and 134 via the first and second measuring units 110 and 130. In this course, the first and second measuring units 110 and 130 measure the amount of supply of the cold/hot raw water and further adjust the pressure of supply of the cold/hot raw water to be constant.

To this end, the first and second measuring units 110 and 130 may take the form of a pressure reducing valve having a flexible diaphragm such as rubber. Within the first and second measuring units 110 and 130 are mounted an impeller rotating with flow of liquid, a counter counting the number of rotation of the impeller, etc. to measure the amount of supply of the cold/hot raw water. For reference, the first and second measuring units 110 and 130 are disclosed in Korean Patent Application Nos. 10-2004-50984 and 10-2004-15194, both of which are owned by the present applicant.

In addition, the bottom plate 200 has a plurality of bottom holes attached closely to the bottom of the middle plate 250 to define a plurality of bottom passages therebetween. A hydrant pipe 216, the shower head pipe 226 and the drain pipe 236 project from the bottom of the bottom plate 200 to be exposed to the outside through the bottom 164 of the bottom case 160. The hydrant 218 is mounted at an end of the hydrant pipe 216, the shower head is mounted at an end of the shower head pipe 226 via a connecting pipe, and a stop valve or a cock such as an adjustable screw 238 is provided in the drain pipe 236. In this case, it is particularly preferable that the hydrant 218 is provided with a slit-shaped discharge port to discharge cold/hot soft water and cold/hot running water in the form of a membrane.

The middle plate 250 has a plurality of middle holes and first and second fixation holes attached closely to the bottom of the cover plate 350 to define a plurality of cover passages therebetween. The regeneration waste water pipe 314 projects from the bottom of the middle plate 250 to be exposed to the outside through the bottom 164 of the bottom case 160. In addition, the middle plate 250 is provided with a sensor hole 310, a temperature sensor 142 to be inserted into the sensor hole 310 from the bottom of the middle plate 250 is located between the middle plate 250 and the cover plate 350, and a sensor bracket 144 to fix the temperature sensor 142 is combined to the bottom of the middle plate 250.

The cover plate 350 is provide with first and second discharge holes 372 and 382 connected to the first and second soft water tanks 710 and 720 and through which the cold/hot soft water or the regeneration waste water is discharged, and a plurality of cover holes. The first and second supply ports 356 and 366 to supply the cold/hot raw water to the first and second soft water tanks 710 and 720, a regeneration raw water pipe 426 to supply the regenerated water to the regeneration tank 730, a drain connecting pipe 434 connected to the drain pipe 236 of the bottom plate 200 to forcedly discharge the regenerated water in the regeneration tank 730, and first to third transfer pipes 406, 410 and 414 connected to the control valve 910 of the discharging part 900 project from the top of the cover plate 350. The regeneration raw water pipe 426 and the drain connecting pipe 434 are directly connected to the bottom of the regeneration tank 730 to bear the weight of the tank part 700 and may be provided with a rib on their respective outer surfaces along a longitudinal direction to prevent the regeneration raw water pipe 426 and the drain connecting pipe 434 from being broken or damaged.

In addition, the first and second valve assemblies 500 and 600 mounted within the main body 152 comprising the bottom case 160, the bottom plate 200, the middle plate 250 and the cover plate 350 comprise first and second rotating disks 560 and 660 rotated by first and second motors 502 and 602, and first and second fixing disks 570 and 670 laid on the first and second rotating disks 560 and 660 and fixed closely to the bottom of the middle plate 250, respectively, as requisite elements. The first and second fixing disks 570 and 670 are provided with first and second disk holes fixed closely to the bottom of the middle plate 250, and, on the top of the first and second rotating disks 560 and 660 are provided first and second rotating passages, respectively, to interconnect the first and second disk holes of the first and second fixing disks 570 and 670 by rotation of the first and second rotating disks 560 and 660.

Thus, moving paths of the cold/hot raw water, the cold/hot running water, the regenerated water and the regeneration waste water are defined by holes formed in the bottom plate 200, the middle plate 250, the cover plate 350 and the first and second fixing disks 570 and 670 and passages formed between the holes, and are properly interconnected for each mode depending on variation of position of the first and second rotating passages according to the rotation of the first and second rotating disks 560 and 660, which will be described in detailed later. In other words, the main body 152 has a plurality of moving paths of liquid defined by the holes formed in the bottom plate 200, the middle plate 250, the cover plate 350 and the passages formed between the holes, the plurality of moving paths are properly disposed through the first and second disk holes of the first and second fixing disks 570 and 670, and the first and second rotating passages properly interconnect the first and second disk holes by the rotation of the first and second rotating disks 560 and 660. Thus, flow of the cold/hot raw water, the cold/hot running water, the regenerated water and the regeneration waste water is controlled for each mode.

Based on the above description, moving paths of liquid for each mode outside the main body 152 may be considered as follows. In the soft water, the cold/hot raw water supplied to the first and second water inlet pipes 112 and 132 of the first and second measuring units 110 and 130 is transferred to the first and second soft water tanks 710 and 720 via the first and second supply ports 356 and 366 of the cover plate 350, the first and second tubes t1 and t2, and the third and fourth supply ports 782 and 792, respectively, and the cold/hot soft water in the first and second soft water tanks 710 and 720 is transferred to the first and second discharge holes 372 an 382 of the cover plate 350, respectively, and is finally discharged to the outside via the hydrant 218 or the shower head pipe 226. In the running mode, the cold/hot raw water supplied to the first and second water inlet pipes 112 and 132 of the first and second measuring units 110 and 130 is, as it is, discharged to the outside via the hydrant 218 and the shower head pipe 226. In the regeneration mode, one of the cold/hot raw water supplied to the first and second water inlet pipes 112 and 132 of the first and second measuring units 110 and 130 is supplied to the regeneration tank 730 via the regeneration raw water pipe 426 of the cover plate 350, the regenerated water in the regeneration tank 730 is supplied to the first and second soft water tanks 710 and 720 via first and second regenerated water passages of the filter cover 780, which will be described later, and the regeneration waste water in the first and second soft tanks 710 and 720 is transferred to the first and second discharge holes 372 and 382 of the cover plate 350 and is finally discharged to the outside via the regeneration waste water pipe 314. In the control mode, the cold/hot raw water supplied to the first and second water inlet pipes 112 and 132 is controlled. Flow of liquid inside the main body 152 will be described in detail in relevant portions of the description.

In addition, the regenerated water in the regeneration tank 730 is discharged to the outside via the drain connecting pipe 434 of the cover plate 350 and the drain pipe 236 of the bottom plate 200. For example, before a user opens the regeneration tank stopper 732 to inject or refill regeneration material in the regeneration tank 730, he/she may loosen the adjustable screw 238 at an end of the drain pipe 236 to remove residual regenerated water in the regeneration tank 730 and lower internal pressure of the regeneration tank 730, and then tighten the adjustable screw 238 to inject or refill the regeneration material in the regeneration tank 730.

In this course, the first and second valve assemblies 500 and 600 control flow of liquid in the main body 152 for each mode by properly interconnecting the holes formed in the first and second fixing disks 570 and 670, the bottom plate 200, the middle plate 250 and the cover plate 350 and the passages formed between the holes based on a degree of rotation of the first and second rotating disks 560 and 660.

Hereinafter, parts of the main body 152 to control flow of liquid inside the main body 152 for each mode will be described in detail with reference to FIGS. 3, 4, 5 and 6.

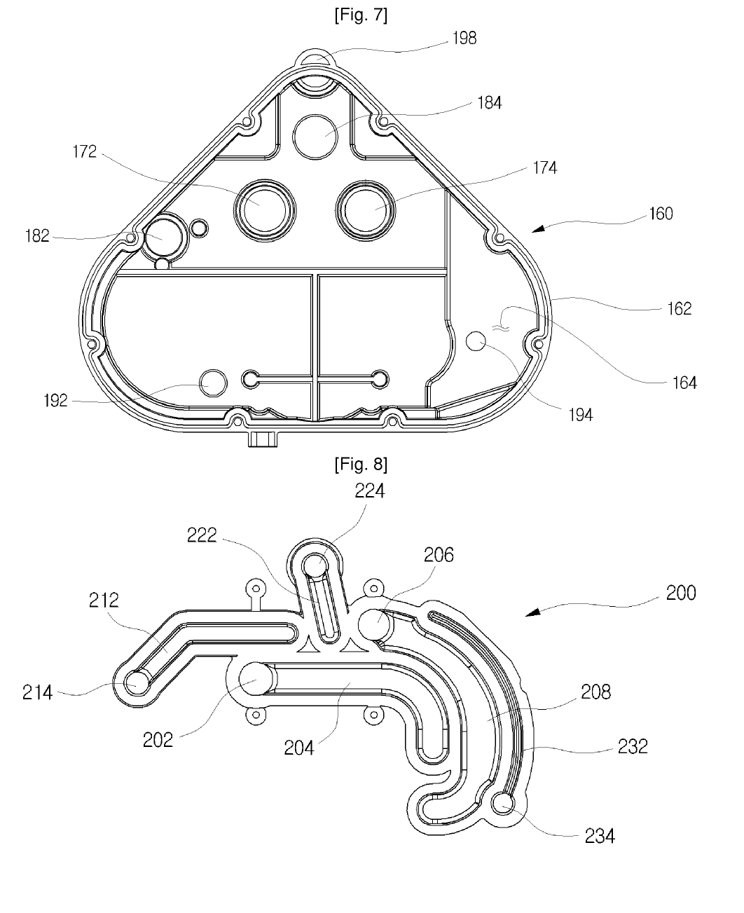

FIG. 7 is a plan view of the bottom case 160, showing the bottom 164 directing toward the tank part 700.

As shown in FIG. 7, the bottom 164 of the bottom case 160 is provided with first to sixth through holes 172, 174, 182, 184, 192 and 194. The first and second water inlet pipes 112 and 132 of the first and second measuring units 110 and 130 are inserted in the first and second through holes 172 and 174, respectively, the hydrant pipe 216 and the shower head pipe 226 of the bottom plate 200 are inserted in the third and fourth through holes 182 and 184, respectively, the regeneration waste water pipe 314 of the middle plate 250 is inserted in the fifth through hole 192, and the drain pipe 236 of the bottom plate 200 is inserted in the sixth through hole 194.

In addition, the bottom of the bottom case 160 is provided with a flange-shaped joining hole 198 into which the stand 240 is fixed. The stand 240 comprises a support pipe 242 inserted in the joining hole 198 and having an inner surface with a screw thread formed thereon, a screw pipe 244 screwed to an end of the support pipe 242 and having an outer surface with a corresponding screw thread formed thereon, and a pedestal 246 made of rubber and inserted in an end of the screw pipe 244. The height of the stand 240 may be adjusted by turning an adjustable screw 248 engaged with the screw pipe 244 (see FIG. 5).

FIG. 8 is a plan view of the bottom plate 200, showing a contact surface adhered closely to the bottom of the middle plate 250, that is, a top side of the bottom plate 200.

As shown in FIG. 8, the bottom plate 200 is provided with first to fifth bottom holes 202, 206, 214, 224 and 234. The first and second water outlet pipes 114 and 134 of the first and second measuring units 110 and 130 are inserted in the first and second bottom holes 202 and 206, respectively, and the third to fifth bottom holes 214, 216 and 234 extend downward via the hydrant pipe 216, the shower head pipe 226 and the drain pipe 236.

On the top of the bottom plate 200 are formed first to fifth bottom grooves 204, 208, 212, 222 and 232 adhered closely to the bottom of the middle plate 250 and extending the first to fifth bottom holes 202, 206, 214, 224 and 234, respectively. On the bottom of the middle plate 250 are formed first to fifth middle grooves corresponding to the first to fifth bottom grooves 204, 208, 212, 222 and 232 of the bottom plate 200. Independent passages are defined when the first to fifth bottom grooves 204, 208, 212, 222 and 232 are adhered closely to the first to fifth middle grooves, respectively, and accordingly, the first to fifth bottom grooves 204, 208, 212, 222 and 232 will be hereinafter called ‘first to fifth bottom passages 204, 208, 212, 222 and 232’ since there is no actual profit to distinguish the grooves from the passages, and reference numerals will be given for the bottom plate 200 to avoid any possible confusion. Likewise, a plurality of passages is defined between the middle plate 250 and the bottom of the cover plate 350, which will be described later. For the purpose of forming these passages, a plurality of corresponding grooves are formed in a contact surface between the middle plate 250 and the cover plate 350, which is called ‘cover passages’, and reference numerals will be given for the bottom of the cover plate 350 to avoid any possible confusion. In addition, a so-called ‘vibration welding’ method may be used to form bottom passages and middle passages between the bottom plate 200 and the middle plate 250 or between the middle plate 250 and the cover plate 350. This method is to weld grooves and projections formed in contact surfaces of two base materials made of thermoplastic resin under a mutually-adhered state using high pressure and vibration. Since this method is well known in the art, detailed description thereof will be omitted to avoid complexity of description.

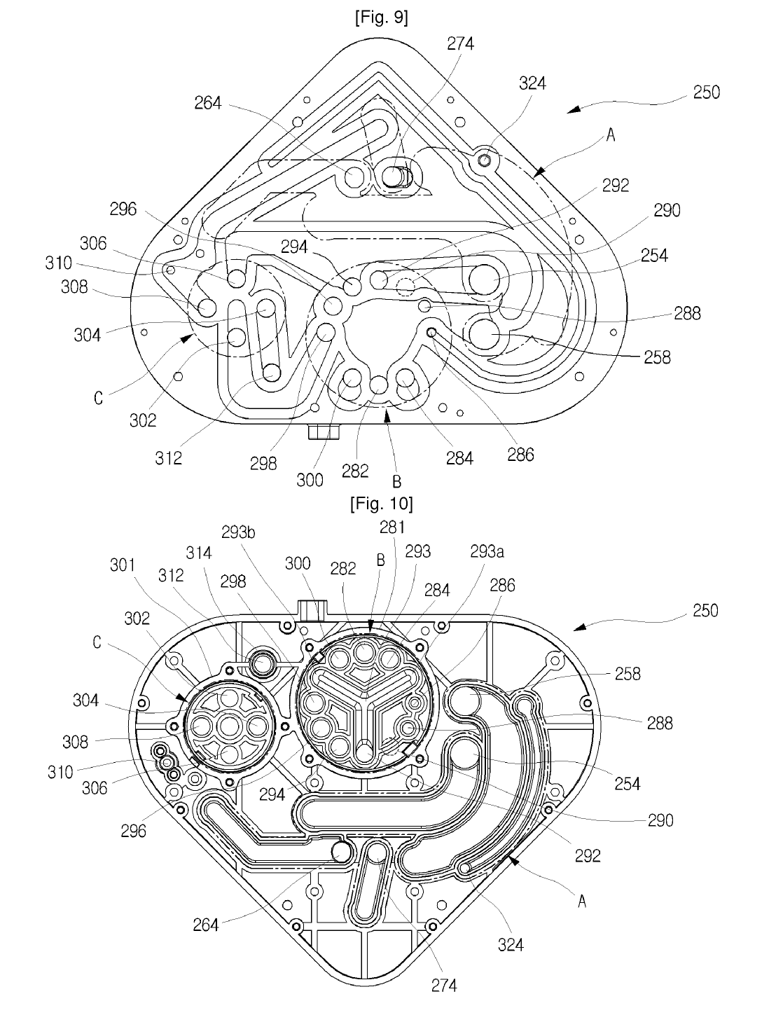

FIGS. 9 and 10 are a plan view and a bottom view of the middle plate 250, respectively, showing the top of the middle plate 250 adhered closely to the cover plate 350 and bottom of the middle plate 250 adhered closely to the bottom plate 200 and the first and second fixing disks 570 and 670.

The middle plate 250 is generally divided into three areas; a passage area A adhered closely to the bottom plate 200, a first circular disk area B adhered closely to the first fixing disk 570, and a second circular disk area C adhered closely to the second fixing disk 670. In addition to the three areas, the middle plate 250 further includes an outer area. First and second cylindrical partitions 281 and 301 surrounding edges of the first and second disk areas B and C project by a predetermined height from the bottom of the middle plate 250, respectively. The first and second partitions 281 and 301 accommodate and fix the first and second fixing disks 570 and 670 and prevent axes of the first and second rotating disks 560 and 660 from being distorted when the first and second rotating disks 560 and 660 are rotated.

In addition, the passage area A in the middle plate 250 is provided first to fifth middle holes 254, 258, 264, 274 and 324, which are connected to the first to fifth bottom holes 202, 206, 214, 224 and 234, respectively, by the first to fifth bottom passages 204, 208, 212, 222 and 232.

In addition, a plurality of first disk holes, i.e., 1st-1 to 1st-9 disk holes 282, 284, 286, 288, 292, 294, 296, 298 and 300, are formed in order in a counterclockwise direction of FIG. 9 (clockwise direction of FIG. 10) along an edge of the first disk area B. A distribution passage 293 extending the 1st-5 disk hole 292 is formed in the rear side of the first disk area B. The distribution passage 293 has a first end 293a extending the 1st-5 disk hole 292 between the 1st-2 disk hole 284 and the 1st-3 disk hole 286 and a second end 293b extending the 1st-5 disk hole 292 between the 1st-8 disk hole 298 and the 1st-9 disk hole 300. In addition, a sealed buffer hole 290 is located between the 1st-4 disk hole 288 and the 1st-5 disk hole 292.

In this case, preferably, the 1st-1 disk hole 282 is located in a 6 o'clock direction of FIG. 9 (12 o'clock direction of FIG. 10), that is, in a position closest to the front side. As a result, in the bottom of the middle plate 250, the 1st-1 disk hole 282, the 1st-2 disk hole 284, the first end 293a of the distribution passage 293, the 1st-3 and 1st-288, the buffer hole 290, the 1st-5 to 1st-8 disk holes 292, 294, 296 and 298, the second end 293b of the distribution passage 293, and the 1st-9 disk hole 300 are arranged in order in the counterclockwise direction of FIG. 9 (the clockwise direction of FIG. 10) along the edge of the first disk area B. Centers of these elements have the same distance, the same radius and the same angle for the center of the first disk area B, which is a rotation axis of the first rotating disk 560 which will be described later. Accordingly, assuming the 1st-1 disk hole 282 of the first disk area B is located in a 6 o'clock direction of FIG. 9 (12 o'clock direction of FIG. 10), the remaining elements except the 1st-1 disk hole 282 are located between 5 o'clock and 7 o'clock counterclockwise direction of FIG. 9 (between 1 o'clock and 11 o'clock clockwise direction of FIG. 10).

In addition, a plurality of second disk holes, i.e., 2nd-1 to 2nd-4 disk holes 302, 304, 306 and 308, are formed in order in the counterclockwise direction of FIG. 9 (clockwise direction of FIG. 10) along an edge of the second disk area C. In this case, preferably, the 2nd-1 disk hole 302 is located in the 6 o'clock direction of FIG. 9 (12 o'clock direction of FIG. 10), that is, in a position closest to the front side. The 2nd-2 to 2nd-4 disk holes 304, 306 and 308 have the same distance, the same radius and the same angle for the center of the second disk area C, which is a rotation axis of the second rotating disk 660, and are located in 3 o'clock, 12 o'clock and 9 o'clock counterclockwise direction of FIG. 9 (3 o'clock, 6 o'clock and 9 o'clock clockwise direction of FIG. 10), respectively.

The outer area is formed with a sixth middle hole 312 extending downward through the regeneration waste water pipe at a rear side of the outer area, and the sensor hole 310 in which the temperature sensor 142 is inserted.

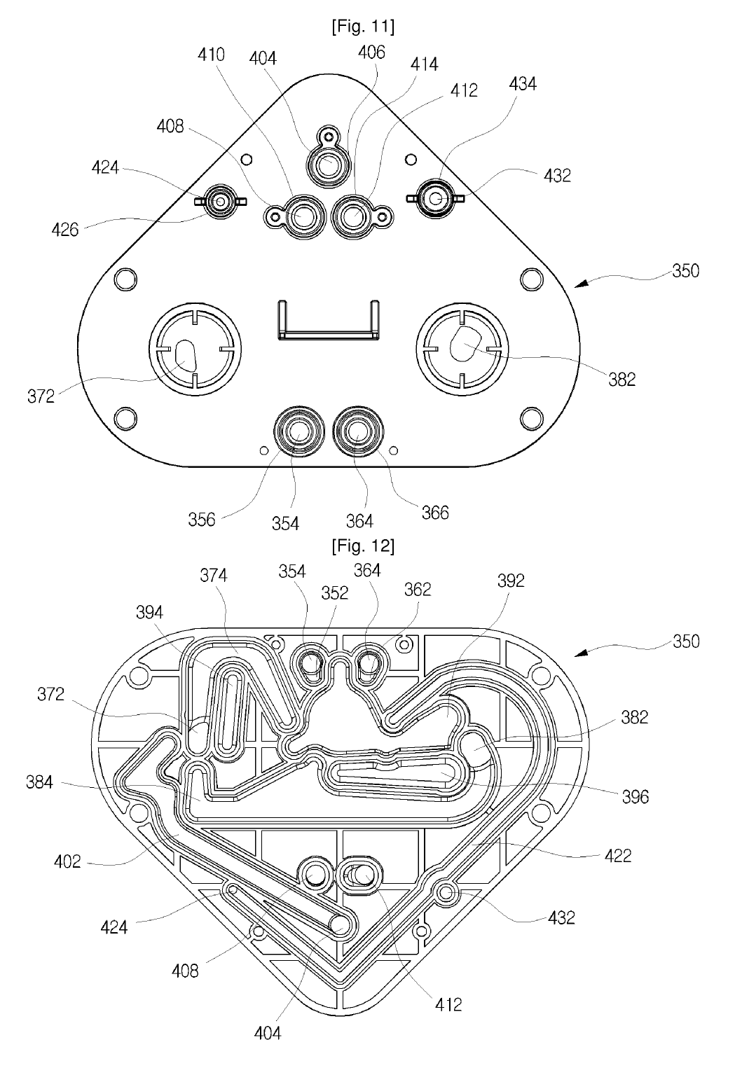

FIGS. 11 and 12 are a plan view and a bottom view of the cover plate 350, respectively, showing the top of the cover plate 350 on which the tank part 700 is mounted and the bottom of the cover plate 350 to which the middle plate 250 is adhered closely.

As shown in the figures, on the top of the cover plate 350 is provided first to seventh cover holes 354, 364, 404, 408, 412, 424 and 432 and first and second discharge holes 372 and 382. On the bottom of the cover plate 350 is provided first to seventh cover passages 352, 362, 392, 394, 396, 402 and 422 and first and second discharge passages 374 and 384.

The first cover passage 352 interconnects the first cover hole 354 to the 1st-9 disk hole 300 of the middle plate 250, the second cover passage 362 interconnects the second cover hole 364 to the 1st-2 disk hole 284 of the middle plate 250, the third cover passage 392 interconnects the second middle hole 258, the 1st-1 disk hole 282, the 1st-4 disk hole 288 and the 1st-7 disk hole 296 of the middle plate 250, the fourth cover passage 394 interconnects the 1st-2 disk hole 304 and the sixth middle hole 312 of the middle plate 250, the fifth cover passage 396 interconnects the 1st-5 disk hole 292 and the first middle hole 254 of the middle plate 250, the sixth cover passage 402 interconnects the 2nd-4 disk hole 308 of the middle plate 250, the sensor hole 310, and the third cover hole 404 of the cover plate 350, and the seventh cover passage 422 interconnects the 1st-3 disk hole 286 of the middle plate 250 and the sixth cover hole 424 of the cover plate 350.

The first discharge passage 374 interconnects the 1st-8 disk hole 298 and the 2nd-1 disk hole 302 of the middle plate 250 and first discharge hole 372 of the cover plate 350, and the second discharge passage 384 interconnects the 1st-6 disk hole 294 and the 2nd-3 disk hole 306 of the middle plate 250 and second discharge hole 872 of the cover plate 350.

The first and second cover holes 354 and 364 are connected to the first and second supply ports 356 and 366 projecting from the top of the cover plate 350, respectively, the third to fifth cover holes 404, 408 and 412 are connected to the first to third transfer pipes 406, 410 and 414 projecting from the top of the cover plate 350, respectively, and the sixth and seventh cover holes 424 and 432 are connected to the regeneration tank 730 via the regeneration raw water pipe 426 and the drain connecting pipe 434 projecting from the top of the cover plate 350, respectively.

The first and second fixing disks 570 and 670 of the first and second valve assemblies 500 and 600 are adhered closely to the top of the first and second disk areas B and C of the bottom of the middle plate 250, respectively, and the first and second rotating disks 560 and 660 are adhered closely to the bottom of the first and second disk areas B and C. The plurality of passages and holes are interconnected under a specified rule by rotation of the first and second rotating disks 560 and 660, thereby allowing the water softener to perform various operation modes.

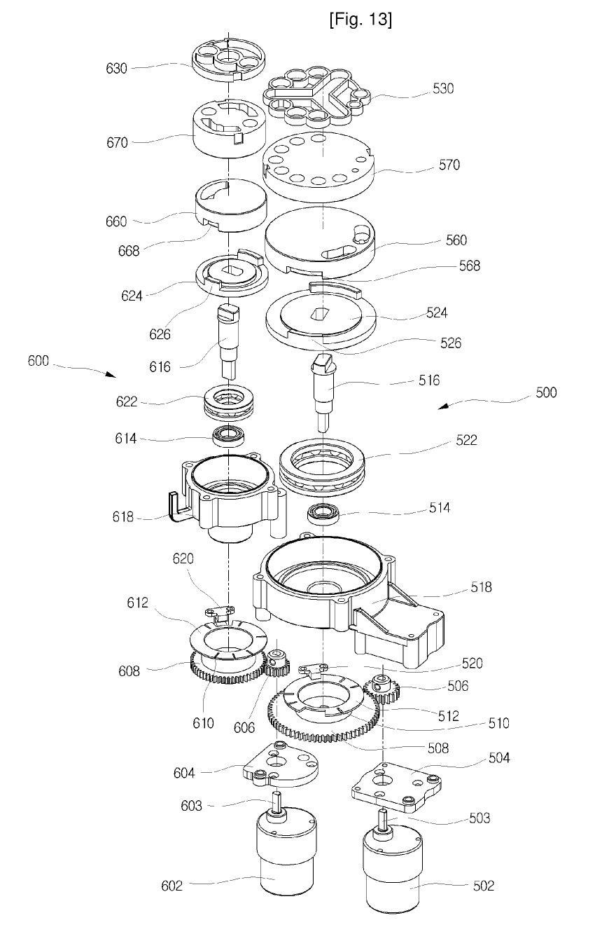

For the operation modes, as shown in FIG. 13 showing an exploded perspective view of the switch valve part 450, the first and second valve assemblies 500 and 600 of the switch valve part 450 includes first and second motors 502 and 602 having first and second rotating axes 503 and 603, respectively, first and second motor brackets 504 and 604 covering the first and second motors 502 and 602 with the first and second rotating axes 503 and 603 exposed, respectively, first and second main gears 506 and 606 combined to the first and second rotating axes 503 and 603 on the first and second motor brackets 504 and 604, respectively, first and second auxiliary gears 508 and 608 engaging with the first and second main gears 506 and 606, respectively, first and second rotating flanges 512 and 612 combined to and rotating with the first and second auxiliary gears 508 and 608 and having a plurality of first and second mark grooves 510 and 610 along their outer sides, respectively, first and second rotating shafts 516 and 616 combined upright to the centers of the first and second auxiliary gears 508 and 608 via first and second bearings 514 and 614, respectively, first and second gear covers 518 and 618 covering the first and second motor brackets 504 and 604, the first and second main gears 506 and 606 and the first and second auxiliary gears 508 and 608 with the first and second rotating shafts 516 and 616 exposed, respectively, first and second optical sensors 520 and 620 fixed to the bottom of the first and second gear covers 518 and 618 and sensing a degree of rotation of the first and second auxiliary gears 508 and 608 by identifying the mark grooves 510 and 610 of the first and second rotating flanges 512 and 612, respectively, and first and second disk brackets 524 and 624 combined to the bottom of the first and second rotating disks 560 and 660 via first and second ball bearings 522 and 622 on the first and second gear covers 518 and 618 with their centers fixed to the first and second rotating shafts 516 and 616, respectively.

Preferably, the first and second disk brackets 524 and 624 are provided with a plurality of first and second combining ends 526 and 626, respectively, the first and second rotating disks 560 and 660 are provided with a plurality of first and second combining grooves 568 and 668 in which the first and second combining ends 526 and 626 are respectively inserted to prevent an idling rotation, and first and second packings 530 and 630 sealing the plurality of holes and passages independently are interposed between the first and second fixing disks 570 and 670 and the middle plate 350, respectively.

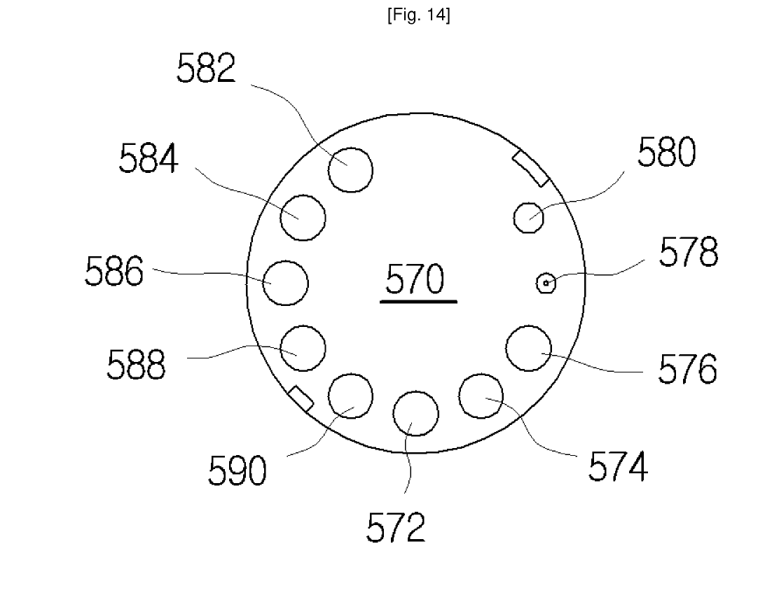

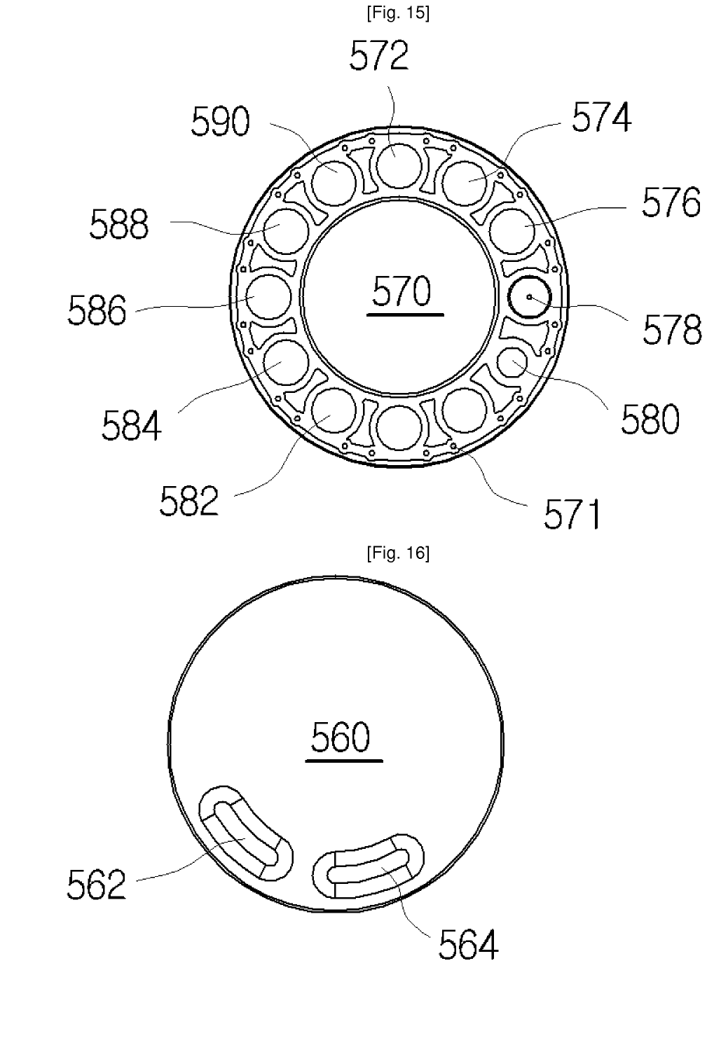

FIGS. 14 and 15 are a plan view and a bottom view of the first fixing disk 570, respectively, showing the top of the first fixing disk 570 adhered closely to the bottom of the middle plate 250 and the bottom of the first fixing disk 570.

As shown in the figures, along an edge of the first fixing disk 570 are formed a plurality of first fixing holes, i.e., a 1st-1 fixing hole 572 corresponding to the 1st-1 disk hole 282 of the middle plate 250, a 1st-2 fixing hole 574 corresponding to the 1st-2 disk hole 284 of the middle plate 250, a 1st-3 fixing hole 576 corresponding to the first end 293a of the distribution passage 293 of the middle plate 250, a 1st-4 fixing hole 578 corresponding to the 1st-3 disk hole 286 of the middle plate 250, a 1st-5 fixing hole 580 corresponding to the 1st-4 disk hole 288 of the middle plate 250, a 1st-6 fixing hole 582 corresponding to the 1st-6 disk hole 294 of the middle plate 250, a 1st-7 fixing hole 584 corresponding to the 1st-7 disk hole 296 of the middle plate 250, a 1st-8 fixing hole 586 corresponding to the 1st-8 disk hole 298 of the middle plate 250, a 1st-9 fixing hole 588 corresponding to the second end 293b of the distribution passage 293 of the middle plate 250, and a 1st-10 fixing hole 590 corresponding to the 1st-9 disk hole 300 of the middle plate 250.

A plurality of first oil grooves 571 are provided in the bottom of the first fixing disk 570 in addition to the 1st-1 to 1st-10 fixing holes 572, 574, 576, 578, 580, 582, 584, 586, 588 and 590. These first oil grooves 571 serve for watertight and lubrication by an oil film when the first fixing disk 570, which will be described below, is adhered closely to the first rotating disk 560. A small quantity of oil is stored in the first oil groves 571.

FIG. 16 is a plan view of the first rotating disk 560, showing the top of the first rotating disk 560 adhered closely to the first fixing disk 570.

As shown in the figure, at least one first rotating passage including 1st-1 and 1st-2 rotating passages 562 and 564 of groove shape is provided in the top of the first fixing disk 570. The 1st-1 and 1st-2 rotating passages 562 and 564 have a shape to interconnect positions corresponding to two pairs of adjacent holes of the first fixing disk 570. For example, the 1st-1 rotating passage 562 of the first rotating disk 560 interconnects the 1st-1 and 1st-2 fixing holes 572 and 574 of the first fixing disk 570, and the 1st-2 rotating passage 564 interconnects the 1st-3 and 1st-4 fixing holes 576 and 578 of the first fixing disk 570. In this manner, the fixing holes of the first fixing disk 570 are sequentially interconnected by the rotation of the first rotating disk 560.

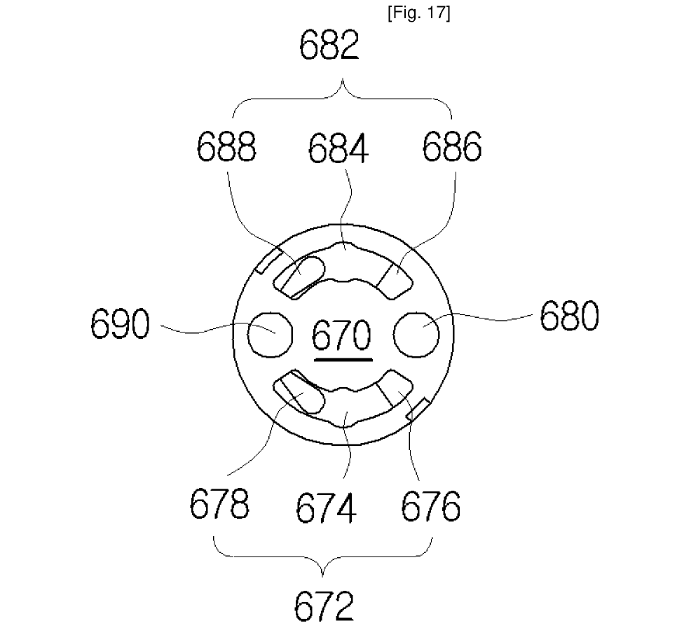

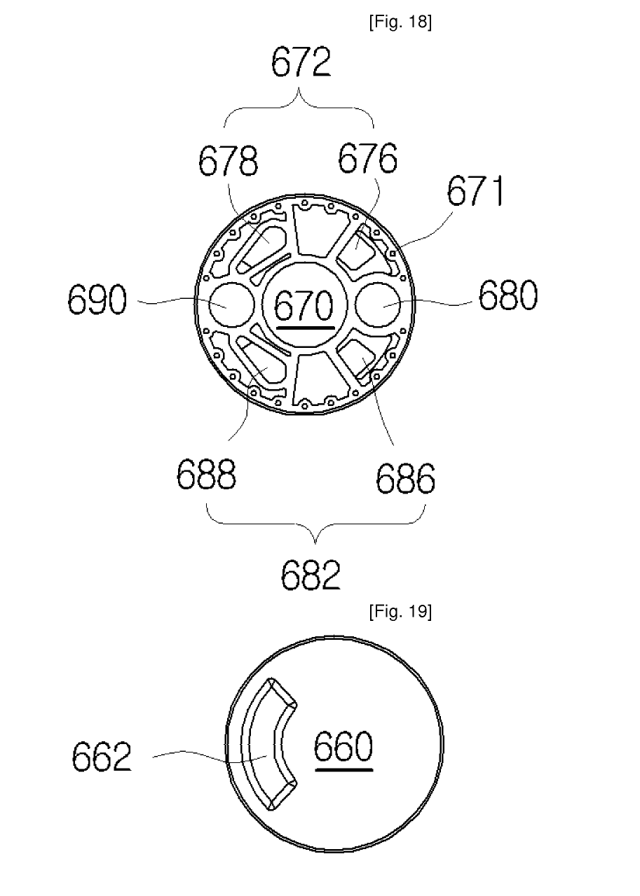

FIGS. 17 and 18 are a plan view and a bottom view of the second fixed disk 670, respectively, FIG. 17 showing the top of the second fixing disk 670 adhered closely to the middle plate 250 and the FIG. 18 showing the bottom of the second fixing disk 670 adhered closely to the second rotating disk 660.

As shown in the figures, in the second fixing disk 670 are formed a plurality of second fixing holes, i.e., a 2nd-1 fixing hole 672 connected to the 2nd-1 disk hole 302 of the middle plate 352, a 2nd-2 fixing hole 680 connected to the 2nd-2 disk hole 304, a 2nd-3 fixing hole 682 connected to the 2nd-3 disk hole 306, and a 2nd-4 fixing hole 690 connected to the 2nd-4 disk hole 308.

Among them, the 2nd-1 fixing hole 672 and the 2nd-3 fixing hole 682 comprise 2nd-1 and 2nd-3 fixing grooves 674 and 684 of an arc shape surrounding an edge of the second fixing disk 670, and first and second extending holes 676 and 678 and third and fourth extending holes 686 and 688, which penetrate ends of the 2nd-1 and 2nd-3 fixing grooves 674 and 684, respectively. Specifically, as shown in the figures, the 2nd-1 fixing hole 672 comprises the 2nd-1 fixing groove hole 674 corresponding to the 2nd-1 disk hole 302 of the middle plate 250, with its both ends extending near the 2nd-2 fixing hole 680 and the 2nd-4 fixing hole 690, and the first extending hole 676 close to the 2nd-2 fixing hole 680 and the second extending hole 678 close to the 2nd-4 fixing hole 690, which penetrate the both ends respectively. Also, the 2nd-3 fixing hole 682 comprises the 2nd-2 fixing groove hole 684 corresponding to the 2nd-3 disk hole 306 of the middle plate 250, with its both ends extending near the 2nd-2 fixing hole 680 and the 2nd-4 fixing hole 690, and the third extending hole 686 close to the 2nd-2 fixing hole 680 and the fourth extending hole 688 close to the 2nd-4 fixing hole 690, which penetrate the both ends respectively.

In this case, the second and fourth extending holes 678 and 688 may have a taper shape that their width decreases to the 2nd-2 fixing hole 690. The reason for the tape shape is that the width of the second and fourth extending holes 678 and 688 has connection with the length of the 2nd-1 rotating passage 662 of the second rotating disk 660, which will be described later, and particularly, a mixture ratio of cold/hot raw water or cold/hot running water is precisely controlled depending on a degree of rotation of the 2nd-1 rotating passage 662, which will be described in a relevant portion of the description.

In addition, a plurality of second oil grooves 671 are provided in the bottom of the second fixing disk 670 in addition to the 2nd-1 to 2nd-4 fixing holes 672, 680, 682 and 690. These second oil grooves 671 serve for watertight and lubrication by an oil film when the second fixing disk 670, which will be described below, is adhered closely to the second rotating disk 660. A small quantity of oil is stored in the second oil groves 671.

FIG. 19 is a plan view of the second rotating disk 660, showing the top of the second rotating disk 660 adhered closely to the bottom of the second fixing disk 670.

A shown in the figure, the 2nd-1 rotating passage 662 is formed on the top of the second rotating disk 660. The 2nd-1 rotating passage 662 connects the 2nd-2 fixing hole 680 and the first and third extending holes 676 and 686 by the rotation of the second rotating disk 660 or connects the 2nd-4 fixing hole 690 and the third and fourth extending holes 678 and 688 by the rotation of the second rotating disk 660.

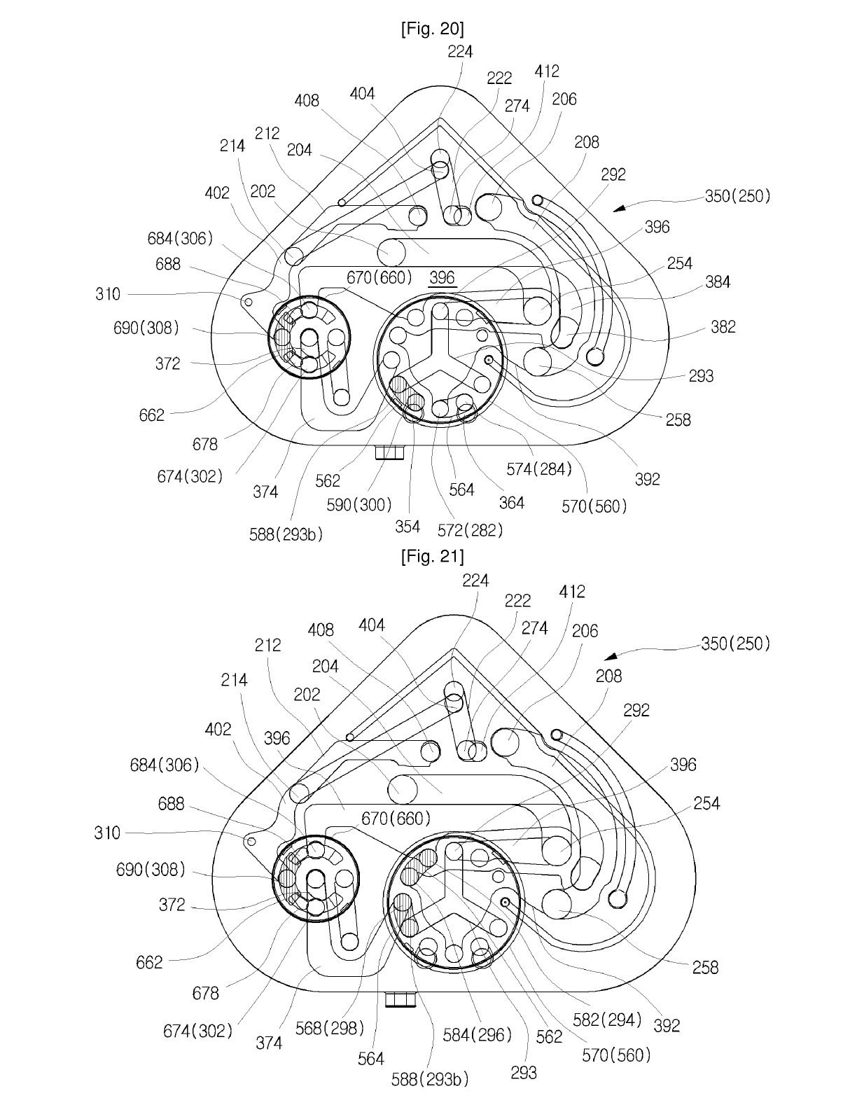

Based on the above description, operation for each mode of the water softener and moving paths of liquid inside the main body 152 will be hereinafter described with reference to FIGS. 20 to 24 in conjunction with the above shown figures. FIGS. 20 to 24 are schematic views illustrating interconnection of the holes and the passages as a portion of the main body 152, where reference numerals of parts independent of flow of liquid in relevant modes are omitted to avoid confusion.

It is noted that the control valve 910 of the discharging part 900 is connected to the first to third transfer pipes 406, 410 and 414 of the bottom plate 350 and plays a role of controlling the third cover hole 404 or selectively connecting the third cover hole 404 to one of the fourth and fifth cover holes 408 and 412 by operation of a user.

1. Soft Water Mode

FIG. 20 shows the soft water mode.

For the soft water mode, the 1st-1 rotating passage 562 of the first rotating disk 560 interconnects the 1st-9 fixing hole 588 and the 1st-10 fixing hole 590 of the first fixing disk 570, and the 1st-2 rotating passage 564 interconnects the 1st-1 fixing hole 572 and the 1st-2 fixing hole 574 of the first fixing disk 570.

The cold raw water supplied through the first water inlet pipe 112 and the first water outlet pipe 114 of the first measuring unit 110 is transferred to the first middle hole 254 of the middle plate 250 via the first bottom hole 202 and the first bottom passage 204 of the bottom plate 200 and then transferred to the 1st-5 disk hole 292 of the middle plate 250 and the distribution passage 293 by the fifth cover passage 396 of the cover plate 350. At this time, the second end 293b of the distribution passage 293 is connected to the 1st-9 fixing hole 588 of the first fixing disk 570 and is again connected to the 1st-10 fixing hole 590 by the 1st-1 rotating passage 562 of the first rotating disk 560, and the 1st-10 fixing hole 590 is connected to the first cover hole 354 via the 1st-9 disk hole 300 of the middle plate 250 and the first cover passage 352 of the cover plate 350. Thus, the cold raw water is supplied to the first soft water tank 710 via the first cover hole 354 and the first supply port 356.

In addition, the hot raw water supplied through the second measuring unit 130 is transferred to the second middle hole 258 of the middle plate 250 via the second bottom hole 206 and the second bottom passage 208 of the bottom plate 200 and then supplied to the 1st-1 disk hole 282 of the middle plate 250 and the 1st-1 fixing hole 572 of the first fixing disk 570 connected thereto by the third cover passage 392 of the cover plate 350. At this time, the 1st-1 fixing hole 572 is connected to the 1st-2 fixing hole 574 by the 1st-2 rotating passage 564 of the first rotating disk 560, and the 1st-2 fixing hole 574 is connected to the second cover hole 364 via the 1st-2 disk hole 284 of the middle plate 250 and the second cover passage 362 of the cover plate 350. Thus, the hot raw water is supplied to the second soft water tank 720 via the second cover hole 364 and the second supply port 366.

On the other hand, for the soft water mode, the 2nd-1 rotating passage 662 of the second rotating disk 660 interconnects the second extending hole 678, the fourth extending hole 688 and the 2nd-4 fixing hole 690 of the second fixing disk 670.

Thus, the cold soft water discharged from the first soft water tank 710 is introduced into the 2nd-1 disk hole 302 of the middle plate 250 while being transferred to the first discharge hole 372 and the first discharge passage 374 of the cover plate 350, and then is transferred to the second extending hole 678 of the second fixing disk 670, and the hot soft water discharged from the second soft water tank 720 is introduced into the 2nd-3 disk hole 306 of the middle plate 250 via the second discharge hole 382 and the second discharge passage 384 of the cover plate 350 and then is transferred to the fourth extending hole 688 of the second fixing disk 670. Thus, the cold/hot soft water is mixed in the 2nd-1 rotating passage 662 of the second rotating disk 660, introduced into the sixth cover passage 402 of the cover plate 350 via the 2nd-4 fixing hole 690 of the second fixing disk 670 and the 2nd-4 disk hole 308 of the middle plate 250, and then transferred to the third cover hole 404.

As described earlier, the third cover hole 404 of the cover plate 350 is controlled by the control valve 910 or is connected to one of the fourth and fifth cover holes 408 and 412. Thus, the cold/hot soft water supplied to the fourth cover hole 408 is transferred to the third bottom hole 214 via the third middle hole 264 of the middle plate 250 and the third bottom passage 212 of the bottom plate 200, and then is finally discharged via the hydrant pipe 216 and the hydrant 218, and the cold/hot soft water supplied to the fifth cover hole 412 is supplied to the fourth bottom hole 224 via the fourth middle hole 274 of the middle plate 250 and the fourth bottom passage 222 of the bottom plate 200, and then is finally discharged to the shower head pipe 226.

Accordingly, a user may use the cold/hot soft water discharged to the hydrant or the shower head.

2. Running Water Mode

FIG. 21 shows the running water mode.

For the running water mode, the 1st-1 rotating passage 562 interconnects the 1st-6 fixing hole 582 and the 1st-7 fixing hole 584 of the first fixing disk 570, and the 1st-2 rotating passage 564 interconnects the 1st-8 fixing hole 586 and the 1st-9 fixing hole 588 of the first fixing disk 570.

The cold raw water supplied to the first bottom hole 202 of the bottom plate 200 is transferred to the first middle hole 254 of the middle plate 250 via the first bottom passage 204 of the bottom plate 200 and then transferred to the 1st-5 disk hole 292 of the middle plate 250 and the distribution passage 293 by the fifth cover passage 396 of the cover plate 350. At this time, the second end 293b of the distribution passage 293 is connected to the 1st-9 fixing hole 588 of the first fixing disk 570 and is again connected to the 1st-8 fixing hole 568, the 1st-8 disk hole 298 of the middle plate 250, the first discharge passage 374 of the cover plate 350, the 2nd-disk hole 302 of the middle plate 250 by the 1st-2 rotating passage 564 of the first rotating disk 560. Thus, the cold raw water is supplied to the 2nd-1 disk hole 302 of the middle plate 250, and the 2nd-1 fixing hole 672, the 2nd-1 fixing groove 674 and the second extending hole 678 of the second fixing disk 670.

In addition, the hot raw water is transferred to the second middle hole 258 of the middle plate 250 via the second bottom hole 206 and the second bottom passage 208 of the bottom plate 200 and then supplied to the 1st-7 disk hole 296 of the middle plate 250 and the 1st-7 fixing hole 584 of the first fixing disk 570 by the third cover passage 392 of the cover plate 350. At this time, the 1st-7 fixing hole 584 is connected to the 1st-6 fixing hole 582 by the 1st-1 rotating passage 562 of the first rotating disk 560 and is again connected to the second discharge passage 396 of the cover plate 350 and the 2nd-3 disk hole 306 of the middle plate 250 by the 1st-6 disk hole 294 of the middle plate 250. Thus, the hot raw water is supplied to the 2nd-3 disk hole 306 of the middle plate 250, and the 2nd-3 fixing hole 682, the 2nd-3 fixing groove 684 and the fourth extending hole 688 of the second fixing disk 670.

On the other hand, for the soft water mode, when the second rotating disk 660 is rotated, the 2nd-1 rotating passage 662 interconnects the second extending hole 678, the fourth extending hole 688 and the 2nd-4 fixing hole 690 of the second fixing disk 670.

Thus, the cold/hot soft water is mixed in the 2nd-1 rotating passage 662 of the second rotating disk 660, introduced into the sixth cover passage 402 of the cover plate 350 via the 2nd-4 fixing hole 690 of the second fixing disk 670 and the 2nd-4 disk hole 308 of the middle plate 250, and then transferred to the third cover hole 404. In this case, the third cover hole 404 of the cover plate 350 is controlled by the control valve 910 or is connected to one of the fourth and fifth cover holes 408 and 412. Thus, the cold/hot running water as the cold/hot raw water supplied to the fourth cover hole 408 is transferred to the third bottom hole 214 via the third middle hole 264 of the middle plate 250 and the third bottom passage 212 of the bottom plate 200, and then is finally discharged via the hydrant pipe 216 and the hydrant 218, and the cold/hot running water as the cold/hot soft water supplied to the fifth cover hole 412 is supplied to the fourth bottom hole 224 via the fourth middle hole 274 of the middle plate 250 and the fourth bottom passage 222 of the bottom plate 200, and then is finally discharged to the shower head pipe 226.

Accordingly, a user may use the cold/hot running water discharged to the hydrant or the shower head.

3. Regeneration Mode

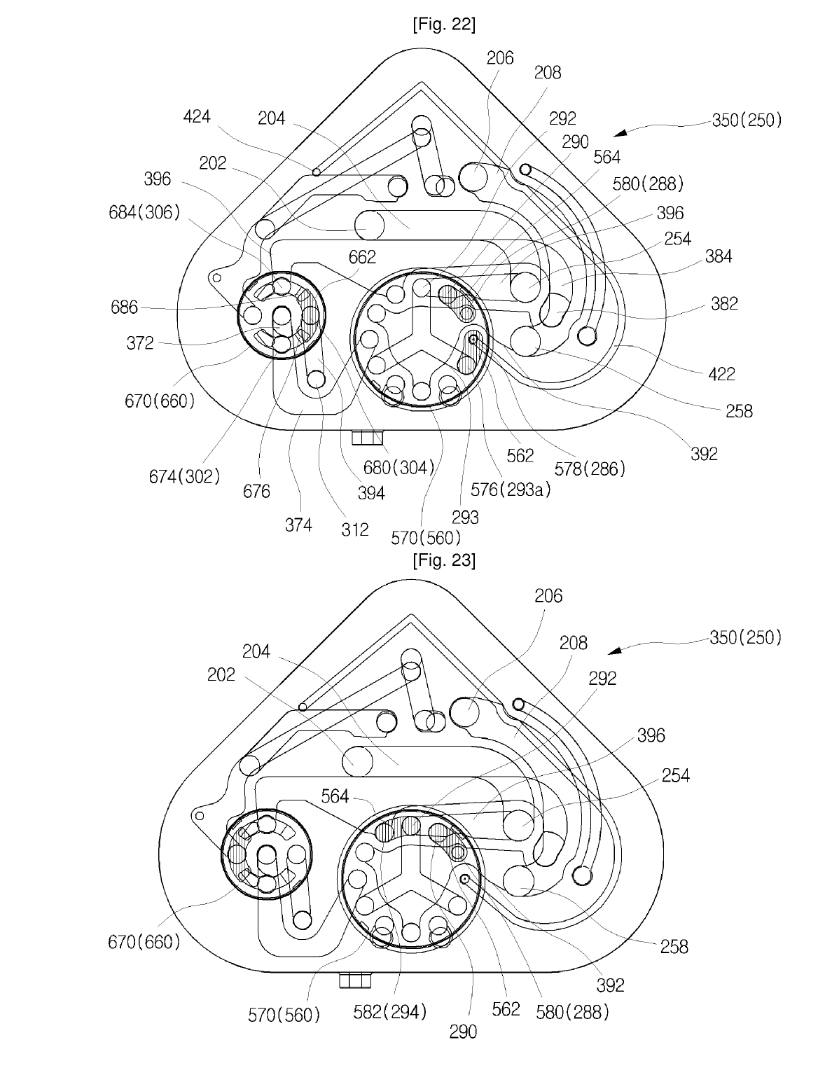

FIG. 22 shows the regeneration mode.

For the regeneration mode, when the first rotating disk 560 is rotated, the 1st-1 rotating passage 562 interconnects the 1st-3 fixing hole 576 and the 1st-4 fixing hole 578 of the first fixing disk 570, and the 1st-2 rotating passage 564 is connected to only the 1st-5 fixing hole 580 of the first fixing disk 570.

The cold raw water supplied to the first bottom hole 202 of the bottom plate 200 is transferred to the first middle hole 254 of the middle plate 250 via the first bottom hole 202 and then transferred to the 1st-5 disk hole 292 of the middle plate 250 and the distribution passage 293 by the fifth cover passage 396 of the cover plate 350. At this time, the first end 293a of the distribution passage 293 is connected to the 1st-3 fixing hole 576 of the first fixing disk 570 and is again connected to the seventh cover passage 422 of the cover plate 350 via the 1st-4 fixing hole 578 and the 1st-3 disk hole 286 of the middle plate 250. Thus, the cold raw water is supplied to the regeneration tank 710 via the sixth cover hole 424 of the cover plate 350 and the regeneration raw water pipe 426, and then supplied to the first and second soft water tanks 710 and 720 by the first and second regenerated water passages, which will be described later.

On the other hand, the hot raw water is transferred to the second middle hole 258 of the middle plate 250 via the second bottom hole 206 and the second bottom passage 208 of the bottom plate 200 and then supplied to the 1st-4 disk hole 288 of the middle plate 250, the 1st-5 fixing hole 580 of the first fixing disk 570, and the 1st-2 rotating passage 564 of the first rotating disk 560 by the third cover passage 392 of the cover plate 350.

In the mean time, for the regeneration mode, when the second rotating disk 660 is rotated, the 2nd-1 rotating passage 662 interconnects the first extending hole 676, the third extending hole 686 and the 2nd-2 fixing hole 680 of the second fixing disk 670.

Thus, the regeneration waste water discharged from the first soft water tank 710 is introduced into the 2nd-1 disk hole 302 of the middle plate 250 while being transferred to the first discharge hole 372 and the first discharge passage 374 of the cover plate 350, and then is transferred to the first extending hole 676 of the second fixing disk 670, and the regeneration waste water discharged from the second soft water tank 720 is introduced into the 2nd-3 disk hole 306 of the middle plate 250 via the second discharge hole 382 and the second discharge passage 384 of the cover plate 350 and then is transferred to the third extending hole 686 of the second fixing disk 670. Thus, the regeneration waste water is mixed in the 2nd-1 rotating passage 662 of the second rotating disk 660, introduced into the fourth cover passage 394 of the cover plate 350 via the 2nd-2 fixing hole 680 of the second fixing disk 670 and the 2nd-2 disk hole 304 of the middle plate 250, and then discharged to the outside via the sixth middle hole 312 of the middle plate 250 an the regeneration waste water pipe 314.

In this case, even a small quantity of the regenerated water is sufficient to recover the ion exchange resin. If the amount of regenerated water is too large, a reverse reaction of the regeneration may happen. Accordingly, the 1st-4 fixing hole 578 of the first fixing disk 570 and the 1st-3 disk hole 286 of the middle plate 250 have a diameter smaller than those of other holes. In this embodiment, the diameter of the 1st-4 fixing hole 578 and the 1st-3 disk hole 286 is smaller than several mm, preferably, 0.5 to 2 mm.

4. Control Mode

FIG. 23 shows the control mode.

For the control mode, when the first rotating disk 560 is rotated, the 1st-1 rotating passage 562 is connected to only the 1st-5 fixing hole 580 of the first fixing disk 570, and the 1st-2 rotating passage 564 is connected to only the 1st-6 fixing hole 582 of the first fixing disk 570.

Thus, the cold raw water transferred to the first bottom hole 202 and the first bottom passage 204 of the bottom plate 200, the first middle hole 254 of the middle plate 250, the fifth cover passage 396 of the cover plate 350, the 1st-5 disk hole 292 of the middle plate 250, and the distribution passage 293 has no further moving path, and also the hot raw water supplied to the 1st-4 disk hole 288 of the middle plate 250, the 1st-5 fixing hole 580 of the first fixing disk 570, and the 1st-1 rotating passage 562 of the first rotating disk 560 via the second bottom hole 206 and the second bottom passage 208 of the bottom plate 200, the second middle hole 258 of the middle plate 250, and the third cover passage 392 of the cover plate 350 has no further moving path.

Accordingly, the rotation of the second rotating disk 660 has nothing to do with this mode. As a result, the water softener goes in the control mode in which all flow of liquid including the supply of the cold/hot raw water is stopped.

Hereinafter, the special modes according to the present invention will be described.

5. Cold/Hot Change Mode

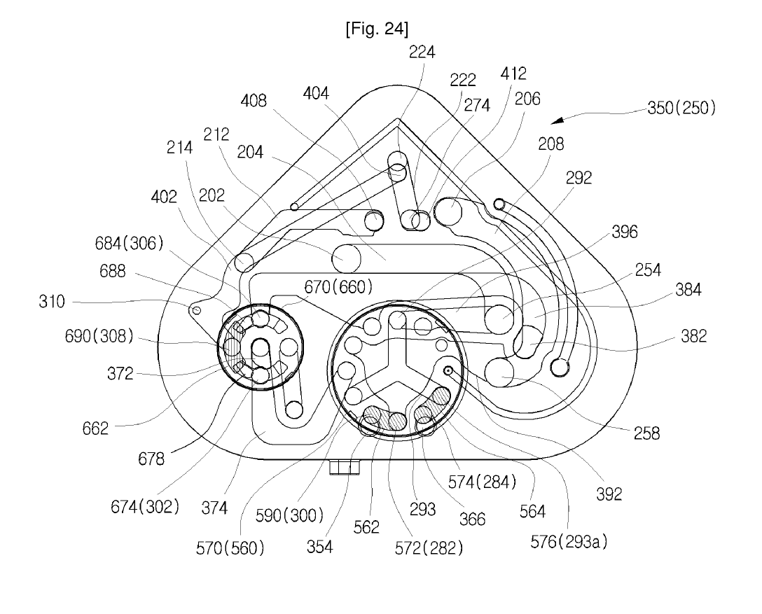

FIG. 24 is a schematic view illustrating the cold/hot change mode as one of the special modes of the water softener.

For the cold/hot change mode, when the first rotating disk 560 is rotated, the 1st-1 rotating passage 562 interconnects the 1st-1 fixing hole 572 and the 1st-10 fixing hole 590 of the first fixing disk 570, and the 1st-2 rotating passage 564 interconnects the 1st-2 fixing hole 574 and the 1st-3 fixing hole 576 of the first fixing disk 570.

As a result, the cold raw water is transferred to the first bottom hole 202 and the first bottom passage 204 of the bottom plate 200, the first middle hole 254 of the middle plate 250, the fifth cover passage 396 of the cover plate 350, the 1st-5 disk hole 292 of the middle plate 250, and the first end 293a of the distribution passage 293, and then supplied to the second soft water tank 720 via the 1st-3 fixing hole 576 of the first fixing disk 570, the 1st-2 rotating passage 564 of the first rotating disk 560, the 1st-2 fixing hole 574 of the first fixing disk 570, the 1st-2 disk hole 284 of the middle plate 250, and the second cover passage 362 and the second cover hole 364 of the cover plate 350.

In addition, the hot raw water is transferred to the second bottom hole 206 and the second bottom passage 208 of the bottom plate 200, the second middle hole 258 of the middle plate 250, the third cover passage 392 of the cover plate 350, and the 1st-1 disk hole 282 of the middle plate 250, and then supplied to the first soft water tank 710 via the 1st-1 fixing hole 572 of the first fixing disk 570, the 1st-1 rotating passage 562 of the first rotating disk 560, the 1st-10 fixing hole 590 of the first fixing disk 570, the 1st-9 disk hole 300 of the middle plate 250, and the first cover passage 352 and the first cover hole 354 of the cover plate 350.

The cold/hot change mode is different from the soft water mode shown in FIG. 20 in that the cold raw water is supplied to the second soft water tank 720 and the hot raw water is supplied to the first soft water tank 710, which results in interchange of the cold/hot raw water between the first and second soft tanks 710 and 720.

Thus, the hot soft water of the first soft water tank 710 is transferred to the first discharge hole 372 of the cover plate 350 and the cold soft water of the second soft water tank 710 is transferred to the second discharge hole 382 of the cover plate 350, with the same subsequent moving path as the soft mode, so that a user can obtain the cold/hot soft water through the hydrant 218 and the shower head pipe 226.

6. Automatic Regeneration Mode

The automatic regeneration mode is a mode in which the control mode, the regeneration mode and the control mode of the four basic modes are performed in order. For the automatic regeneration mode, it can be seen from the above description without a separate figure that the automatic regeneration can be performed by rotation of the first and second rotating disks 560 and 660.

7. Flow Regulation Mode

The flow regulation mode is a mode in which the specified amount of the cold/hot soft water and the cold/hot running water is discharged in the soft water mode and the running water mode and these modes change to the control mode. For the flow regulation mode, it can be also seen from the above description without a separate figure that the automatic regeneration can be performed by rotation of the first and second rotating disks 560 and 660.

8. Temperature Regulation Mode

As described earlier, the cold/hot soft water and the cold/hot running water supplied to the user in the soft water mode, the running water mode and the cold/hot change mode pass through the temperature sensor 142 inserted in the sensor hole 310 via the sixth cover passage 402 of the cover plate 350.

For the temperature regulation mode, based on a result of sensing of the temperature sensor 142, a degree of rotation of the 2nd-1 rotating passage 662 of the second rotating disk 660 can be controlled to regulate a degree of opening/closing relative to the second and fourth extending holes 768 and 668 of the second fixing disk 670, so that a mixture ratio of the cold/hot soft water or the cold/hot running water finally discharged is properly adjusted to an intended temperature (see FIGS. 20, 21 and 24)

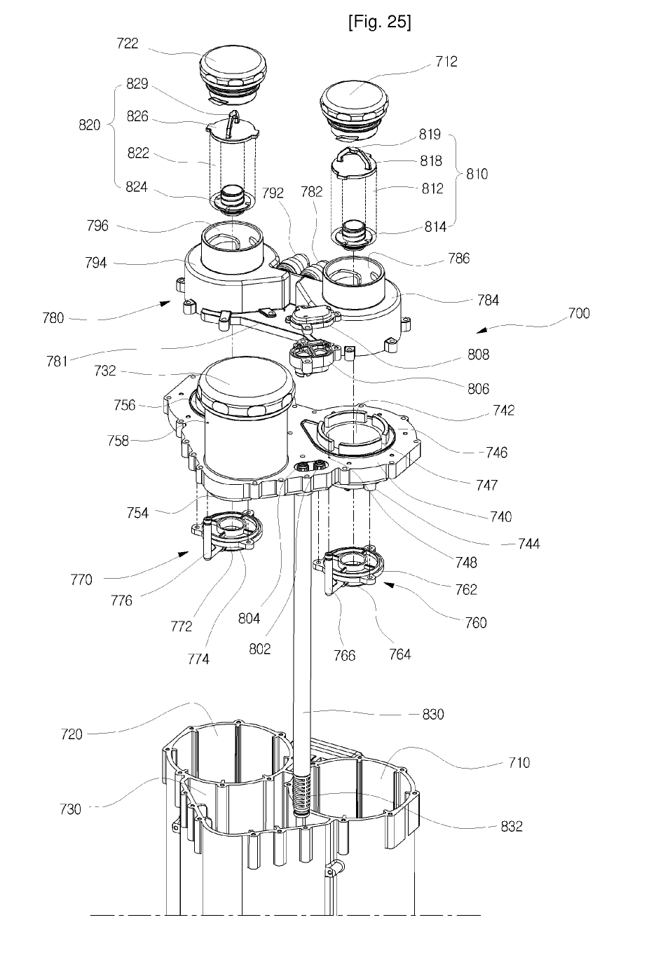

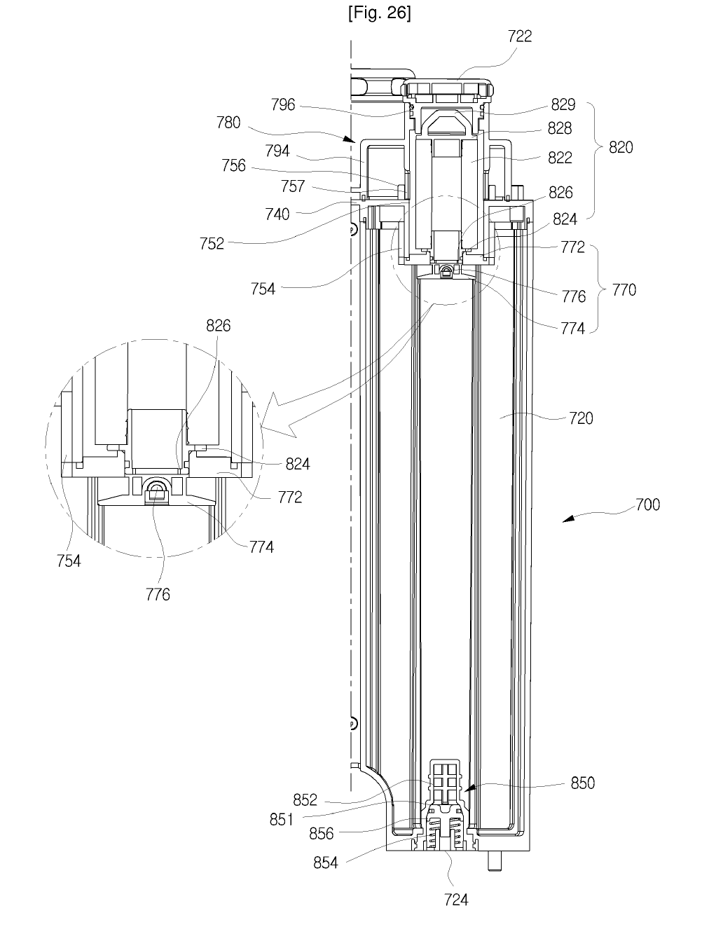

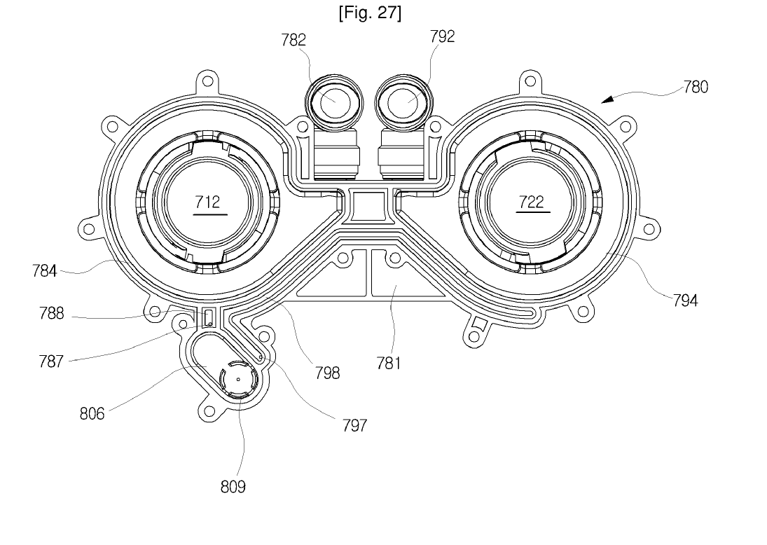

FIGS. 25 to 27 are views illustrating the tank part 700, FIG. 25 showing an exploded rear side perspective view of a portion of the tank part 700, FIG. 26 showing a sectional view of a portion of the tank part 70, and FIG. 27 showing a bottom view of the filter cover 780 of the tank part 700.

It has been shown in FIGS. 3 and 4 that the tops of the first and second soft water tanks 710 and 720 and the regeneration tank 730 are covered with the lid plate 740, portions of the lid plate 740 corresponding to the first and second soft water tanks 710 and 720 are covered with the filter cover 780 provided with the first and second filter stoppers 712 and 722, and the filter cover 780 is provided with the third and fourth supply ports 782 and 792 connected to the first and second soft water tanks 710 and 720, respectively.

The portions of the lid plate 740 corresponding to the first and second soft water tanks 710 and 720 are formed with first and second filter holes 742 and 752. First and second supports 760 and 770 are combined to bottoms of the first and second filter holes 742 and 752 to provide a filter space in which the first and second pre-filters 810 and 820 are mounted. In this case, first and second guide flanges 744 and 754 of a cylinder shape extending the first and second filter holes 742 and 752 project from the bottom of the lid plate 740, and the first and second supports 760 and 770 are combined to bottoms of the first and second guide flanges 744 and 754, respectively, to give sufficient depth to the filter space.

In addition, a plurality of first and second guides 746 and 756 surrounding the first and second filter holes 742 and 752, respectively, project the top of the lid plate 740. The first and second guides 746 and 756 have first and second intervals 747 and 757 through which the cold/hot raw can pass smoothly, respectively.

In addition, the cover filter 780 mounted on the lid plate 740 comprises a filter plate 781 adhered closely to the top of the lid plate 740, and first and second filter housings 784 and 794 covering the first and second filter holes 742 and 752 and the first and second guides 746 and 756, with the filter plate 781 interposed therebetween. The first and second filter stoppers 712 and 722 and the third and fourth supply ports 782 and 792 are provided in the first and second filter housings 784 and 794, respectively.

Thus, the filter space connected to the first and second soft water tanks 710 and 720 via the first and second filter holes 742 and 752 is defined within the first and second filter housings 784 and 794. The first and second pre-filters 810 and 820 are inserted in the filter space.

The pre-filters 810 and 820 comprise first and second filter bodies 812 and 822 of a hollowed cylinder shape, first and second lower frames 814 and 824 covering bottoms of the first and second filter bodies 812 and 822, and first and second upper frames 818 and 828 covering tops of the first and second filter bodies 812 and 822, respectively. The first and second lower frames 814 and 824 are formed with first and second through holes 826 communicating to the inside of the first and second filter bodies 812 and 822, respectively, and first and second grips 819 and 829 project upward from the first and second upper frames 818 and 828, respectively, to draw out and reattach the first and second pre-filters 810 and 820 simply for replacement or repair. Although not shown with reference numerals, cylindrical lower flanges to be inserted in the first and second filter bodies 812 and 822 project downward from the bottoms of the first and second upper frames 818 and 828, respectively, and cylindrical upper flanges to be inserted in the first and second filter bodies 812 and 822 project upward from the tops of the first and second lower frames 814 and 824, respectively. In this case, the first and second through holes 824 of the first and second lower frames 814 and 824 are located in the upper flanges, respectively.

In addition, the first and second supports 760 and 770 comprise first and second supporting plates 762 and 772 of a ring shape combined to bottoms of the first and second guide flanges 744 and 754, and first and second distribution plates 764 and 774 facing the first and second supporting plates 762 and 772 with gaps therebetween, respectively.

Thus, when the first and second pre-filters 810 and 820 are inserted in the first and second filter housings 784 and 794, respectively, edges of the first and second pre-filters 810 and 820 are supported by the first and second supports 760 and 770 in the filter space. When the cold/hot raw water is supplied into the first and second filter housings 784 and 794 of the filter cover 780 via the third and fourth supply ports 782 and 792, the cold/hot raw water is introduced into the first and second filter bodies 812 and 822 of the first and second pre-filters 810 and 820 via the first and second intervals 747 and 757 while circling along the first and second guides 746 and 756. In this course, impurities contained in the cold/hot raw water are filtered out. Subsequently, the cold/hot raw water in the first and second filter bodies 812 and 822 passes the first and second through holes 826 of the first and second lower frames 814 and 824 and the first and second supporting plates 762 and 772 of the first and second supports 760 and 770, and then is evenly supplied into the first and second soft water tanks 710 and 720 by the first and second distribution plates 764 and 774.

The first and second filter bodies 812 and 822 may include a hollow fiber membrane filter or a sediment filter as a filter having a fine texture of less than 10 [symbol] , and may be added with functional substance such as activated carbon or vitamin, if necessary,

As described earlier, the regenerated water in the regeneration tank 730 is supplied to the first and second soft water tanks 710 and 720 via the first and second regenerated water passages defined between the lid plate 740 and the filter cover 780. Hereinafter, a structure for supplying the regenerated water in the regeneration tank 720 to the first and second soft water tanks 710 and 720, including the first and second regenerated water passages, will be described.

The lid plate 740 is formed with first and second regenerated water holes 748 and 758 providing a valve space and communicating to the first and second soft water tanks 710 and 720. A regenerated water producing pipe 830 is drawn out of the bottom of the valve space and is inserted in the regeneration tank 730. The valve space may comprise a housing 806 provided at one sides of the filter housings 784 and 794 and a cover 808 covering the housing 806. First and second regeneration check valves 802 and 804 are disposed in the inside of the valve space. A lower portion of the regenerated water producing pipe 830 has the form of a mesh 832 of a predetermined size to allow only the regenerated water except regeneration material to be introduced in the valve space, and an end of the regenerated water producing pipe 830 is connected to the regeneration raw water pipe 426 (see FIGS. 5 and 6) inserted in the regeneration tank 730.

In the bottom of the filter cover 780 are formed with grooves connecting the housing 806 to the first and second regenerated water holes 748 and 758, thereby defining the first and second regenerated water passages 788 and 798 between the lid plate 740 and the filter cover 780 by close adhesion therebetween.

Specifically, as shown in FIG. 27, the first regenerated water passage 788 connects the first valve hole 787 communicating to the housing 806 and the regenerated water producing pipe 830 to the first regenerated water hole 748 via the first check valve 802, and the second regenerated water passage 798 connects the second valve hole 797 communicating to the housing 806 and the regenerated water producing pipe 830 to the second regenerated water hole 758 via the second check valve 804.

Thus, when the raw water is supplied into the regeneration tank 730 via the regeneration raw water pipe 426 (see FIGS. 5 and 6) drawn out of the main body 152 and to which the regeneration raw water is supplied, the regenerated water is supplied into the housing 806 via the mesh 832 at the lower portion of the regenerated water producing pipe 830 due to rising of an internal pressure of the regeneration tank 730, and the regenerated water in the housing 806 is distributed to the first and second valve holes 787 and 797 and is supplied into the first and second soft water tanks 710 and 720 via the first and second regenerated water passages 788 and the first and second regenerated water holes 748 and 758. A reference numeral 809 in FIG. 27 represents a fixture combined with the regenerated water producing pipe 830. Preferably, in this case, in the bottom of the lid plate 740 are provided first and second regenerated water transfer pipes 766 and 776 led to centers of the first and second distribution plates 764 and 774 of the first and second supports 760 and 770, respectively. The regenerated water is supplied into the first and second soft water tanks 710 and 720 via the first and second regenerated water transfer pipes 766 and 776. In addition, the first and second regeneration check valves 802 and 804 are opened in the direction of the first and second valve holes 787 and 797, respectively, and prevent the regenerated water from flowing backward in the opposite direction, for example, from the first and second regenerated water passages 788 and 798 to the housing 806.

In addition, as shown in FIG. 26, on the bottom of the second soft water tank 720 is formed an ejection hole 724 communicating to the second discharge hole 382 of the cover plate 350 of the main body 152 (see FIGS. 5 and 6). In the ejection hole 724 is mounted a check valve 850 to prevent the ion exchange resin from being lost and flowing backward. The check valve 850 comprises a mesh cover 852 having a cup shape covering the ejection hole 724 and providing a valve inlet 851 extending the ejection hole 724, and a packing member 856 mounted within the mesh cover 852 and blocking the valve inlet 851 by an elastic force of a spring 854. The spring 854 exerts the elastic force upward to block the valve inlet 851. Thus, the check valve 850 is opened to only the direction of the second discharge hole 382, and accordingly, the soft water and the regeneration waste water in the soft water tank 720 open the valve inlet 851 by pushing the packing member 856 and the spring 854 by self-weight, respectively, and are discharged via the ejection hole 724 and the second discharge hole 382 (see FIGS. 5 and 6), respectively, while the liquid flowing backward from the second discharge hole 382 can not be introduced into the second soft water tank 720 as the packing member 856 blocks the valve inlet 851. It is to be understood that the check valve 850 may be applied to the first soft water tank 710 in the same manner.

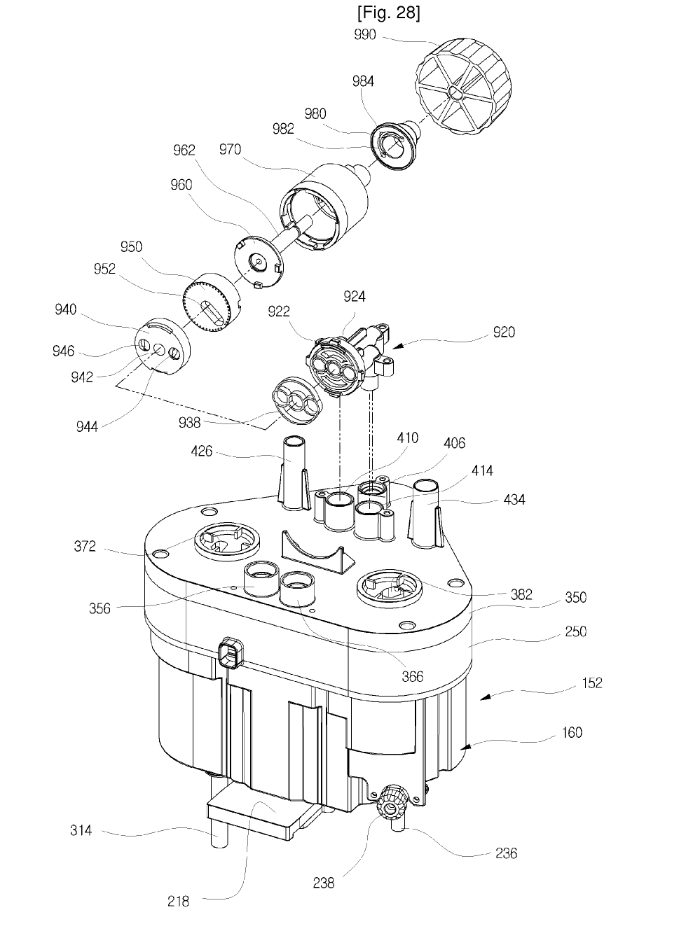

FIG. 28 is an exploded perspective view illustrating the control valve 910 of the discharging part 900 disassembled from the main body 152.

As described earlier, the control valve 910 is connected to the first to third transfer pipes 406, 410 and 414 projecting from the top of the cover plate 350 of the main body 152 and allows a user to selectively supply or control the cold/hot soft water or the cold/hot running water, which is transferred to the first transfer pipe 406, to the second or third transfer pipe 410 or 414.

To this end, the control valve 910 comprises a valve housing 920 connected to the first to third transfer pipes 406, 410 and 414 to extend the first to third transfer pipes 406, 410 and 414 to a valve plate 922, and a valve cover 970 covering the valve plate 922 to provide a space therein. In the valve housing 920 and the valve cover 970 are mounted a valve fixing disk 940 to provide first to third connecting holes 942, 944 and 946 on a straight line, communicating to the first to third transfer pipes 406, 410 and 414, respectively, by closely contacting the valve plate 922, and a valve rotating disk 950 adhered closely to an outer surface of the valve fixing disk 940 and interconnecting the first and second connecting holes 942 and 944 or the first and third connecting holes 942 and 946 or controlling the first connecting hole 942 by being rotated by the handle 990.

More specifically, as shown in the figure, the valve fixing disk 940 has a disk shape adhered closely to the valve plate 922 of the valve housing 920 and is formed with the first to third connecting holes 942, 944 and 946 communicating to the first to third transfer pipes 406, 410 and 414, respectively. A packing 938 is interposed between the valve plate 922 and the valve fixing disk 940, and the second and third connecting holes 944 and 946 of the valve fixing disk 940 are located at the same distance from the first connecting hole 942 placed therebetween.

On one side of the valve rotating disk 950 adhered closely to the valve fixing disk 940 is provided a valve passage 952 that interconnects the first and second connecting holes 942 and 944 or the first and third connecting holes 942 and 946 of the valve fixing disk 940 by rotation of the valve rotating disk 950 or seals the first connecting hole 942 by disconnecting the first connecting hole 942 from the second and third connecting holes 944 and 946.

In addition, the other side of the valve rotating disk 950 is combined with a shaft 962 via a valve disk bracket 960. The shaft 962 is drawn out to the outside of the valve cover 970 and has an end combined with the handle 990 handled by a user.

Thus, when the user turns the handle 990, the valve passage 952 of the valve rotating disk 950 interconnects the first and second connecting holes 942 and 944 of the valve fixing disk 940 so that the cold/hot soft water or the cold/hot running water of the first transfer pipe 406 can be supplied to the second transfer pipe 410 and finally discharged via the hydrant 218. In addition, when the user turns the handle 990, the valve passage 952 of the valve rotating disk 950 interconnects the first and third connecting holes 942 and 946 of the valve fixing disk 940 and accordingly interconnects the first and third transfer pipes 406 and 414 so that the cold/hot soft water or the cold/hot running water can be discharged via the shower head pipe 226 (see FIGS. 4 and 6). In addition, by locating the first connecting hole 942 of the valve fixing disk 940 at a position where the first connecting hole 942 does not communicate to other connecting holes 944 and 946, the valve passage 952 of the valve rotating disk 950 can control the cold/hot soft water or the cold/hot running water.

Preferably, a stopper cap 980 rotating with the shaft 962 is mounted in the handle 990. Also, a guide groove 982 and a stopper groove 984 in the middle of the guide groove 982 are formed in one side of the stopper cap 980 facing the valve cover 970, and a ball bearing (not shown) adhered closely to and rotating along the guide groove 982 by a specified pressure is mounted in an outer surface of the valve cover 970 facing the stopper cap 984. The stopper groove 984 occupies a fixed position of the handle 990 in the above cases, that is, the case where the cold/hot soft water or the cold/hot running water is discharged to the hydrant 218, the case where the cold/hot soft water or the cold/hot running water is discharged to the shower head pipe 226, and the case where the cold/hot soft water or the cold/hot running water is controlled.

Now, pipelines shown in FIG. 2 but not particularly mentioned will be considered based on the above description.

The first and second raw water supply pipelines L1 and L2 are respectively substituted with the first and second bottom holes 202 and 206 and the first and second bottom passages 204 and 208 of the bottom plate 200, the first and second middle holes 254 and 258 of the middle plate 250, the fifth and third cover passages 396 and 392 of the cover plate 350, the 1st-1, 1st-4, 1st-5 and 1st-7 disk holes 282, 288, 292 and 296 of the middle plate 250, and the distribution passage 293. The first and second tank supply pipelines L3 and L4 are respectively substituted with the 1st-9 and 1st-2 disk holes 300 and 284 of the middle plate 250, the first and second cover passages 352 and 362, the first and second cover holes 354 and 364 and the first and second supply ports 356 and 366 of the cover plate 350, the first and second tubes t1 and t2, and the third and fourth supply ports 782 and 792 of the filter cover 780. The regeneration raw water pipeline L5 is substituted with the 1st-3 disk hole 286 of the middle plate 250 and the seventh cover passage 422 and the sixth cover hole 424 of the cover plate 350. The first and second raw water transfer pipelines L6 and L7 and the first and second tank discharge pipelines L8 and L9 are respectively substituted with the first and second discharge passages 374 and 384 of the cover plate 350 and the 2nd-1 and 2nd-3 disk holes 302 and 306 of the middle plate 250. The first and second regenerated water pipelines L10 and L11 are respectively substituted with the housing 806 of the lid plate 740 and the filter cover 780, the first and second valve hole 787 and 797, the first and second regenerated water passages 788 and 798, and the first and second regenerated water holes 748 and 758. The discharge pipeline L12 is substituted with the 2nd-4 disk hole 308 of the middle plate 250 and the sixth cover passage 402, the third cover hole 404 and the first transfer pipe 406 of the cover plate 350. The regeneration waste water pipeline L13 is substituted with the 2nd-2 disk hole 304 of the middle plate 250, the fourth cover passage 394 of the cover plate 350, and the sixth middle hole 312 and the regeneration waste water pipe 314 of the middle plate 250. The drain pipeline L14 is substituted with the regenerated water pipe 434 and the seventh cover hole 432 of the cover plate 350, the fifth middle hole 324 of the middle plate 250, and the fifth bottom passage 232, the fifth bottom hole 234 and the drain pipe 236 of the bottom plate 200.

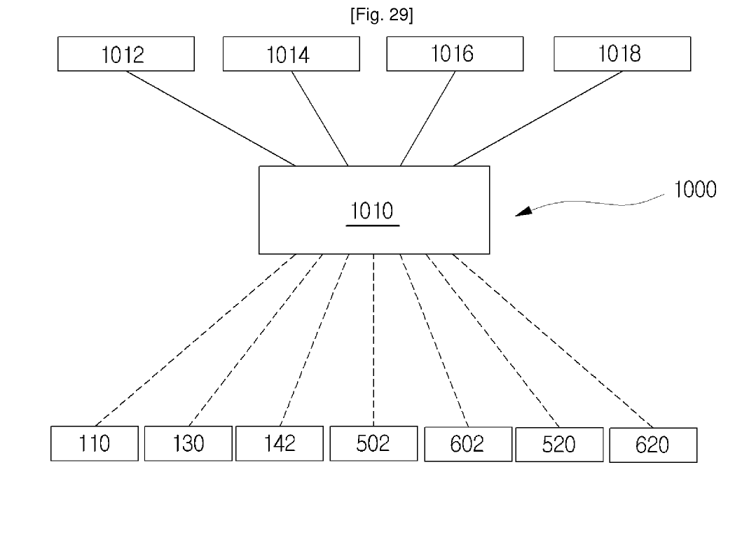

FIG. 29 is a block diagram of the controller 1000 of the water softener according to the embodiment of the present invention. Hereinafter, an overall operation of the water softener will be described with reference to FIG. 29 in conjunction with FIG. 2 and the following figures.

The controller 100 of the water softener performs the four basic modes and the four special modes by controlling the first and second valve assemblies 500 and 600 of the switch valve part 450 according to user's instructions. To this end, the controller 1000 includes the input unit 1012, the display unit 1014, and a logic circuit 1010, and may further include a timer 1016, a speaker 1018, etc.

The input unit 1012 may comprise a plurality of buttons or dials to input the user's instructions. The user's instructions may include instructions to assign one of the four basic modes and the four special mode and combinations thereof. The display unit 1014 comprising a display device such as a liquid crystal display (LCD) displays inputs of the user, operation conditions of the water softener, various required data such as the amount of flow, temperature, etc. of cold/hot raw water and cold/hot soft water, and a manual for user's convenience, etc. The logic circuit 1010 containing an algorithm for control of operations and modes of the input unit 1012 and the display unit 1014 may be embodied by a memory, a microcomputer, etc.

More specifically, the logic circuit 1010 controls an overall operation of the water softener by controlling degree and direction of rotation of the first and second rotating axes 503 and 603 of the first and second motors 502 and 602 of the switch valve part 450 based on results of measurement of the first and second measuring units 110 and 130 and results of sense of the temperature sensor 142 of the main body 152 and the first and second optical sensors 520 and 620 of the switch valve part 450. That is, as described earlier, the amount of flow of the cold/hot raw water can be detected by the first and second measuring units 110 and 130 of the supplying part 100, the temperature of the cold/hot soft water and the cold/hot running water discharged from the water softener 100 can be detected by the temperature sensor 142 of the main body 152, and the current position and degree of the first and second rotating disks 560 and 660 can be detected by the first and second optical sensors 520 and 620 of the switch valve part 450.

When the degree and direction of rotation of the first and second rotating axes 503 and 603 of the first and second motors 502 and 602 are controlled, the four basic modes and the four special modes can be performed.

Hereinafter, each of the four basic modes and the four special modes will be described in brief.

First, among the four basic modes, a user selects the soft water mode or the running water mode using the buttons or dials provided in the input unit 1012 of the controller 1000. Then, the logic circuit 1010 determines the degree and direction of rotation of the first and second rotating axes 503 and 603 of the first and second motors 502 and 602 and performs the soft water mode or the running water mode by rotating the first and second rotating disks 560 and 660. Thus, cold/hot soft water or cold/hot running water is transferred to the control valve 910 of the discharging part 900, and finally the user can directly operate the handle 990 of the control valve 910 to receive and use the cold/hot soft water or the cold/hot running water via the hydrant 218 or the shower head.

In addition, when the user selects the regeneration mode or the control mode through the input unit 1012 of the controller 1000, the logic circuit 1010 determines the degree and direction of rotation of the first and second rotating axes 503 and 603 of the first and second motors 502 and 602 and performs the regeneration mode or the control mode by rotating the first and second rotating disks 560 and 660. In this course, the first and second optical sensors 520 and 620 of the switch valve part 450 sense the current position and the rotation conditions of the first and second rotating disks 560 and 660 to perform the regeneration mode or the control mode precisely.

Next, the cold/hot change mode in which capability of softening of the ion exchange resin filled in the first and second soft water tanks 710 and 720 can be uniformly adjusted will be considered.

The cold/hot change mode is needed, for example, during summer when a great deal of cold soft water is used, or during winter when a great deal of hot soft water is used. In this case, if one of the first and second soft water tanks 710 and 720 is more frequently used than the other, and accordingly, a regeneration cycle of ion exchange resin of the corresponding soft water tank 710 or 720 arrives quickly, which results in difference in lifetime between the first and second soft water tanks 710 and 720.

To avoid this lifetime difference, the user can select the cold/hot change mode through the input unit 1012 of the controller 1000, and then, the logic circuit 1010 calculates the amount of supply of cold/hot raw water in the soft water mode based on results of measurement of the first and second measuring units 110 and 130 and results of sense of the first and second optical sensors 520 and 620. If the amount of use of one of the cold soft water and the hot soft water is too large, the logic circuit 1010 determines the degree and direction of rotation of the first and second rotating axes 503 and 603 of the first and second motors 502 and 602 and interchanges the cold/hot soft water supplied to the first and second soft water tanks 710 and 720. Such a cold/hot change operation is repeated until the user inputs a stop instruction.

Thus, the regeneration cycle and lifetime of the ion exchange resin in the first and second soft water tanks 710 and 720 can be uniformly controlled.

Next, the automatic regeneration mode in which a regeneration time of the ion exchange resin is detected precisely and the regeneration mode is automatically performed will be considered.

The regeneration time of the ion exchange resin can be calculated based on the amount of supply of the cold/hot raw water measured by the first and second measuring units 110 and 130 of the supplying part 100 in the soft water mode.

When it is determined that the regeneration time of the ion exchange resin arrives, the regeneration mode is automatically performed. If necessary, the user can be informed of the automatic regeneration mode through the display unit 1014 or by producing alert sound or voice announcement using the speaker 1018. Preferably, the automatic regeneration mode can be performed at midnight when the water softener is not used so much. When the timer 1016 indicates an appropriate time, the logic circuit 1010 of the controller 1000 determines the degree and direction of rotation of the first and second rotating axes 503 and 603 of the first and second motors 502 and 602, rotates the first and second rotating disks 560 and 660 to perform the automatic regeneration mode, and turns to the control mode when the regeneration is completed.

In this case, the appropriate time and the automatic regeneration mode may be selected by the user.

Next, the temperature regulation mode in which the temperature of the cold/hot soft water or the cold/hot running water becomes equal to a temperature desired by a user will be considered.

For the temperature regulation mode, the user inputs the kind and temperature of water desired by him/her through the input unit 1012 of the controller 1000, and the logic circuit 1010 rotates the first rotating disk 560 to select the soft water mode or the running mode to meet the inputted kind of water, and meets the temperature of the soft water or the running water with the inputted temperature based on the degree of rotation of the second rotating disk 660 and the results of sense of the temperature sensor 142.

Finally, the flow regulation mode in which the amount of discharge of the cold/hot soft water or the cold/hot raw water is regulated will be considered. The flow regulation mode is needed, for example, in a case where a user catches water in a bathtub, and particularly, a case where water of intended kind and amount is received in a bathtub at an intended time using the timer 1016.

For the flow regulation mode, when the user selects intended kind and amount of water through the input unit 1012 of the controller 1000, the logic circuit 1010 rotates the first rotating disk 560 to select the soft water mode or the running mode to meet the selected kind of water, controls the amount of discharge of the cold/hot soft water or the running water, based on results of sense of the first and second measuring units 110 and 130 of the supplying part 100, that is, the amount of supply of the cold/hot raw water, and turns to the control mode when the amount of discharge of the cold/hot soft water or the running water arrives at the intended amount of water.

As described above, the water softener can provide various convenient functions by proper combinations of the four basic modes and the four special modes. For example, it is possible to provide intended amount and temperature of water by mixing the cold/hot soft water and the cold/hot running water and utilize the water softener in various ways according to other purposes.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1-55. (canceled)

56. A water softener, comprising:
a tank part comprising first and second soft water tanks filled with the ion exchange resin and a regeneration tank connected to the first and second soft water tanks and filled with the regeneration material;
a switch valve part comprising a first valve assembly driven by first motor to connect first and second raw water supply pipelines to which cold/hot raw water is supplied to the first and second soft water tanks or to the regeneration tank, and a second valve assembly driven by second motor to connect a discharge pipeline from which the cold/hot soft water and cold/hot running water are discharged to the first and second soft water tanks or to the first valve assembly or to connect a regeneration waste water pipeline from which regeneration waste water is discharged to the first and second soft water tanks; and
a controller comprising an input unit for input of user's instructions and a display unit for display of data, and performing
soft water mode in which the first valve assembly connects the first and second raw water supply pipelines to the first and second soft water tanks and the second valve assembly connects the first and second soft water tanks to the discharge pipeline,
running water mode in which the first and second valve assemblies connect the first and second raw water supply pipelines to the discharge pipeline,
regeneration mode in which the first valve assembly connects the first or second raw water supply pipeline to the regeneration tank and the second valve assembly connects the first and second soft water tanks to the regeneration waste water pipeline and
control mode in which the first valve assembly controls the first and second raw water supply pipelines, by controlling rotation of the first and second motors according to the user's instruction.

57. The water softener according to claim 56, further comprising first and second measuring units that are provided in the first and second raw water supply pipelines, respectively, and measure the amount of the cold/hot raw water, wherein the controller further performs, according to the instruction based on the calculated amount of the flow of the cold/hot raw water, at least one of
cold/hot change mode in which, when performing the soft water mode, the first valve assembly connects the first and second raw water supply pipelines to the first and second soft water tanks in a manner opposite to that of the soft water mode,
automatic regeneration mode in which, when performing the control mode, the control mode is automatically switched to the regeneration mode, and
flow regulation mode in which, when performing the soft water mode or the running water mode, the soft water mode or the running water mode is automatically switched to the control mode.

58. The water softener according to claim 57, further comprising a temperature sensor that is provided in the discharge pipeline and senses the temperature of the cold/hot soft water and the cold/hot running water, wherein the controller further performs temperature regulation mode in which the mixture ratio of cold/hot soft water in the soft water mode or the mixture ratio of the cold/hot running water in the running water mode is controlled according to the instruction based on the sensed temperature of the cold/hot soft water or the cold/hot running water.

59. The water softener according to claim 56, further comprising first and second optical sensors that sense the a degree of rotation of the first and second motors, respectively, wherein the controller controls the rotation of the first and second motors based on a result of sense of the first and second optical sensors.

60. The water softener according to claim 56, further comprising:
a switch valve that is disposed on an end of the discharge pipeline;
a hydrant comprising a slit-shaped ejection hole and connected to the switch valve; and
a shower head pipeline and a shower head that are connected to the switch valve,
wherein the switch valve finally controls the discharge pipeline or connects the discharge pipeline to at least one of the hydrant and the shower head in the soft water mode and the running water mode.

61. The water softener according to claim 56, further comprising:
a main body, having a triangular prism shape whose width becomes small from the front side to the rear side, in which the tank part is mounted and the switch valve is incorporated; and
a bar-shaped stand that projects the main body downward to adjust a height and supports a floor,
wherein the first and second soft water tanks have a cylinder shape located in the right and left of the front side facing a user and the regeneration tank has a triangular prism shape whose width becomes small from the front side to the rear side and is located in the rear side between the first and second soft water tanks.

62. The water softener according to claim 61, wherein the main body comprises:
a cover plate in which the tank part is mounted;
a middle plate adhered closely to the bottom of the cover plate;
a bottom plate adhered closely to the bottom of the middle plate; and
a bottom case that accommodates the switch valve part and is combined to the bottom of the middle plate,
wherein the bottom plate is formed with first and second bottom holes connected to the first and second raw water supply pipelines, respectively, the cover plate is formed with first and second cover holes that are connected to the first and second soft water tanks, respectively, and supply the cold/hot raw water, a third cover hole that is connected to the regeneration tank and supplies the regeneration raw water, a fourth cover hole that is connected to the discharge pipeline and discharges the cold/hot soft water and the cold/hot running water, and first and second discharge holes that are connected to the first and second soft water tanks, respectively, and discharge the cold/hot soft water and the regeneration waste water, the middle plate is formed with a plurality of first and second disk holes and a first middle hole connected to the regeneration waste water pipeline, one or more of the plurality of first disk holes being connected to two selected from the plurality of second disk holes, the first and second bottom holes, and the first to third cover holes, respectively, and one or more of the plurality of second disk holes being connected to the first middle hole and the fourth cover hole, respectively, and the first and second valve assemblies interconnect two or more selected from the first and second disk holes for each of the modes, respectively.

63. The water softener according to claim 62, wherein the first valve assembly comprises:
a first fixing disk that is adhered closely to the bottom of the middle plate and is formed with a plurality of first fixing holes connected to ones selected from the first disk holes, respectively, along an edge of the middle plate; and
a first rotating disk that is adhered closely to the bottom of the first fixing disk and is formed with one or more first rotating passages interconnecting two or more selected from the plurality of first fixing holes for each of the modes by rotation of the first rotating disk,
and wherein the second valve assembly comprises:
a second fixing disk that is adhered closely to the bottom of the middle plate and is formed with a plurality of second fixing holes connected to ones selected from the second disk holes, respectively, along an edge of the middle plate; and
a second rotating disk that is adhered closely to the bottom of the second fixing disk and is formed with one or more second rotating passages interconnecting two or more selected from the plurality of second fixing holes for each of the modes by rotation of the second rotating disk.

64. The water softener according to claim 63, further comprising a plurality of oil grooves formed in the bottom of at least one selected from the first and second rotating disks, oil for lubrication and watertight being stored in the oil grooves,
wherein the plurality of first disk holes comprises one or more 1st-1 disk holes connected to the first bottom hole, one or more 1st-2 disk holes connected to the second bottom hole, one or more 1st-3 disk holes connected to the first cover hole, one or more 1st-4 disk holes connected to the second cover hole, one or more 1st-5 disk holes connected to the third cover hole, and one or more 1st-6 and 1st-7 disk holes connected to two selected from the second disk holes, respectively, and wherein the plurality of second disk holes comprises one or more 2nd-1 disk holes connected to the first discharge hole, one or more 2nd-2 disk holes connected to the second discharge hole, one or more 2nd-3 disk holes connected to the first middle hole, and one or more 2nd-4 disk holes connected to the fourth cover hole,
the plurality of first fixing holes comprises 1st-1 and 1st-2 fixing holes connected to the 1st-1 disk hole, 1st-3 to 1st-5 fixing holes connected to the 1st-2 disk hole, a 1st-6 fixing hole connected to the 1st-3 disk hole, a 1st-7 fixing hole connected to the 1st-4 disk hole, a 1st-8 fixing hole connected to the 1st-5 disk hole, a 1st-9 fixing hole connected to the 1st-6 disk hole, and a 1st-10 fixing hole connected to the 1st-7 disk hole, and wherein the plurality of second fixing holes comprises a 2nd-1 fixing hole connected to the 2nd-1 disk hole, a 2nd-2 fixing hole connected to the 2nd-2 disk hole, a 2nd-3 fixing hole connected to the 2nd-3 disk hole, and a 2nd-4 fixing hole connected to the 2nd-4 disk hole,
the diameter of the 1st-8 fixing hole is 0.5 to 2 mm which is the smallest of the diameters of the first fixing holes.

65. The water softener according to claim 64, wherein the middle plate is further formed with second and third middle hole, a first bottom passage interconnecting the first bottom hole and the second middle hole and a second bottom passage interconnecting the second bottom hole and the third middle hole are defined between the middle plate and the bottom plate, and a first cover passage interconnecting the second middle hole and the lst-1 disk hole, a second cover passage interconnecting the third middle hole and the lst-2 disk hole, a third cover passage interconnecting the first cover hole and the lst-3 disk hole, a fourth cover passage interconnecting the second cover hole and the lst-4 disk hole, a fifth cover passage interconnecting the third cover hole and the lst-5 disk hole, a sixth cover passage interconnecting the fourth cover hole and the 2nd-4 disk hole, a first discharge passage interconnecting the first discharge hole, the 2nd-l disk hole and the lst-7 disk hole, and a second discharge passage interconnecting the second discharge hole, the lst-6 disk hole and the 2nd-2 disk hole, further comprising a distribution passage defined between the middle plate and the first fixing disks and connecting the lst-1 disk hole to the lst-1 and lst-2 fixing holes.

66. The water softener according to claim 64, wherein the 1st-3 fixing hole is located in a 6 o'clock direction, the 1st-7, 1st-2, 1st-8 and 1st-4 fixing holes are located in 5, 4, 3 and 2 o'clock directions, respectively, and the 1st-6, 1st-1, 1st-9, 1st-5 and 1st-10 fixing holes are located in 7, 8, 9, 10 and 11 o'clock directions, respectively,
the first rotating passage comprises 1st-1 and 1st-2 rotating passages interconnecting positions of the fixing holes in two adjacent o'clock direction with an interval of one hour, the 1st-1 rotating passage interconnects the 1st-1 and 1st-6 fixing holes and the 1st-2 rotating passage interconnects the 1st-3 and 1st-7 fixing holes in the soft water mode, the 1st-1 rotating passage interconnects the 1st-10 and 1st-5 fixing holes and the 1st-2 rotating passage interconnects the 1st-9 and 1st-1 fixing holes in the running water mode, the 1st-1 rotating passage corresponds to the 1st-4 and the 1st-2 rotating passage interconnects the 1st-2 and 1st-8 fixing holes in the regeneration mode, and the 1st-1 rotating passage corresponds to the 1st-4 and the 1st-2 rotating passage corresponds to the 1st-10 fixing hole in the control mode
the 2nd-1 fixing hole is located in a 6 o'clock direction, and the 2nd-2, 2nd-3, and 2nd 4 fixing holes are located in 12, 3, and 9 o'clock directions, respectively,
and the second rotating passage of the second rotating disk comprises a 2nd-1 rotating passage interconnecting the 2nd-1 fixing hole, the 2nd-2 fixing hole and the 2nd 4 fixing hole in the soft water mode and the running water mode and interconnecting the 2nd-1 fixing hole, the 2nd-3 fixing hole and the 2nd-4 fixing hole in the regeneration mode.

67. The water softener according to claim 62, wherein the cover plate is formed with fifth and sixth cover holes, and the bottom plate is formed with third and fourth bottom holes connected to the fifth and sixth cover holes, respectively, further comprising:
a control valve that is provided on the top of the cover plate and interconnects the fourth and fifth cover holes or the fourth and sixth cover holes, or seals the fourth cover hole;
a hydrant pipe extending the third bottom hole downward to penetrate the bottom case;
a hydrant that has an ejection hole of a slit shape and is connected to an end of the hydrant pipe of the outside of the bottom case;
a shower head pipe extending the fourth bottom hole downward to penetrate the bottom case; and a shower head connected to an end of the shower head pipe of the outside of the bottom case.

68. The water softener according to claim 62, wherein the cover plate is further formed with a fifth cover hole that is connected to the regeneration tank and discharges regenerated water in the regeneration tank, the middle plate is further formed with a second middle hole connected to the fifth cover hole, and the bottom plate is further formed with a third bottom hole connected to the second middle hole, further comprising:
a drain pipe that extends the third bottom hole downward from the bottom of the bottom plate to penetrate the bottom case;
a stop valve formed at an end of the drain pipe of the outside of the bottom case;
a regeneration raw water pipe that extends the third cover hole from the top of the cover plate to be inserted in the bottom of the regeneration tank; and
a drain connecting pipe that extends the fifth cover hole from the top of the cover plate to be inserted in the bottom of the regeneration tank.

69. The water softener according to claim 61, further comprising:
a lid plate that covers the top of the first and second soft water tanks and the regeneration tank and is formed with first and second valve holes connected to the first and second soft water tanks, respectively;
a filter cover that is adhered closely to the top of the lid plate to cover the first and second valve holes and includes first and second valve housings connected to the first and second raw water supply pipelines, respectively;
first and second pre-filters that are mounted in the first and second valve holes, respectively; and
a plurality of first and second guides that project upward along circumferences of the first and second valve holes, with regular intervals between the plurality of first and second guides, wherein the cold/hot raw water is supplied into the first and second soft water tanks after impurities contained in the cold/hot raw water are filtered out while circling along outer sides of the first and second guides in the first and second valve housings and being introduced into the first and second valve assemblies, respectively.

70. The water softener according to claim 69, further comprising:
valve chambers that are provided in the lid plate and are connected to the first and second soft water tanks, respectively;
a regenerated water producing pipe that communicates to the valve chambers and projects downward from the bottom of the lid plate to be inserted in the regeneration tank;
first and second regenerated water holes that are formed in the lid plate to be connected to the first and second soft water tanks, respectively;
first and second regenerated water passages that are defined between the lid plate and the filter cover and connect the valve chambers to the first and second regenerated water holes, respectively; and
first and second regenerated water connecting pipes that are provided in the first and second soft water tanks, respectively, to extend the first and second regenerated water holes upward.
